(19) United States
(12) Patent Application Publication
(10) Pub. No.: US 2025/0274836 A1
(43) Pub. Date: Aug. 28, 2025

(54) METHOD AND APPARATUS FOR COMPLIANCE CHECK IN COMMUNICATION SYSTEM

(71) Applicant: LENOVO (BEIJING) LIMITED, Beijing (CN)

(72) Inventors: Lianhai Wu, Beijing (CN); Le Yan, Shanghai (CN); Congchi Zhang, Shanghai (CN); Mingzeng Dai, Shanghai (CN)

(21) Appl. No.: 18/857,917

(22) PCT Filed: Apr. 19, 2022
(86) PCT No.: PCT/CN2022/087692

§ 371 Date: Oct. 18, 2024

(51) Int. Cl. H04W 36/36; H04W 76/15

(52) U.S. Cl. CPC H04W 36/362; H04W 76/15

(57) ABSTRACT

Embodiments of the present disclosure relate to methods and apparatuses for compliance check in a communication system. According to some embodiments of the disclosure, a UE may: receive, from a BS, an RRC reconfiguration message for mobility; and transmit, to the BS, an RRC complete message in response to receiving the RRC reconfiguration message for mobility. The RRC reconfiguration message for mobility may be associated with an enhanced CPA or an enhanced CPC.

### TECHNICAL FIELD

Embodiments of the present disclosure generally relate to communication technology, and more particularly to a compliance check in a communication system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

A UE may receive a radio resource control (RRC) reconfiguration message from a BS. The RRC reconfiguration message may include various configurations for the UE. The UE may perform a compliance check on the RRC reconfiguration message, and may act according to the result of the compliance check.

Solutions for performing a compliance check in a communication system are provided.

### SUMMARY

Some embodiments of the present disclosure provide a user equipment (UE). The UE may include: a transceiver; and a processor coupled to the transceiver. The processor may be configured to: receive, from a first base station (BS), a first radio resource control (RRC) reconfiguration message for mobility; and transmit, to the first BS, an RRC complete message in response to receiving the first RRC reconfiguration message for mobility, wherein the first RRC reconfiguration message for mobility is associated with an enhanced conditional primary secondary cell (PSCell) addition (CPA) or an enhanced conditional PSCell change (CPC).

In some embodiments of the present disclosure, the processor may be further configured to perform at least one of the following: performing a first CHO procedure to the target primary cell of the master cell group according to the first CHO configuration, and performing a compliance check on the first configuration for the enhanced CPA in response to performing the first CHO procedure; performing a second CHO procedure to the target primary cell of the master cell group and the target primary cell of the secondary cell group according to the second CHO configuration, and performing a compliance check on the second configuration for the enhanced CPC in response to performing the second CHO procedure; performing a CPA procedure with the target primary cell of the secondary cell group according to the third configuration for a CPA, and performing a compliance check on the third configuration for the enhanced CPC in response to performing the CPA procedure; or performing a CPC procedure with the target primary cell of the secondary cell group according to the fourth configuration for a CPC, and performing a compliance check on the fourth configuration for the enhanced CPC in response to performing the CPC procedure.

In some embodiments, the processor may be further configured to perform at least one of the following: in the case of a failure in the compliance check on the first configuration for the enhanced CPA, transmitting failure information to the target primary cell of the master cell group in response to the first CHO procedure being successful; in the case of a failure in the compliance check on the second configuration for the enhanced CPC, transmitting failure information to the target primary cell of the master cell group in response to the second CHO procedure being successful; in the case of a failure in the compliance check on the third configuration for the enhanced CPC, transmitting failure information to the first BS or the target primary cell of the secondary cell group in response to the CPA procedure being successful; or in the case of a failure in the compliance check on the fourth configuration for the enhanced CPC configuration, transmitting failure information to the first BS or the target primary cell of the secondary cell group in response to the CPC procedure being successful.

In some embodiments, the failure information may indicate at least one of the following: a ID of the candidate primary cell of the secondary cell group associated with the first configuration for the enhanced CPA, the second configuration for the enhanced CPC, the third configuration for the enhanced CPC, or the fourth configuration for the enhanced CPC; or a failure type as a reconfiguration failure for enhanced CPA or CPC.

In some embodiments of the present disclosure, the first RRC reconfiguration message for mobility may include: a first conditional handover (CHO) configuration indicating a target primary cell of a master cell group and a first configuration for the enhanced CPA associated with a candidate primary cell of a secondary cell group, wherein the enhanced CPA is performed after the CHO is performed and an execution condition for the enhanced CPA is met; a second CHO configuration indicating a target primary cell of a master cell group and a target primary cell of a secondary cell group and a second configuration for the enhanced CPC associated with a candidate primary cell of a secondary cell group, wherein the enhanced CPC is performed after the CHO is performed and an execution condition for the enhanced CPC is met; a third configuration for a CPA associated with a target primary cell of a secondary cell group and a third configuration for the enhanced CPC associated with a candidate primary cell of a secondary cell group, wherein the enhanced CPC is performed after the CPA is performed and an execution condition of the enhanced CPC is met; or a fourth configuration for a CPC associated with a target primary cell of a secondary cell group and a fourth configuration for the enhanced CPC associated with a candidate primary cell of a secondary cell group, wherein the enhanced CPC is performed after the CPC is performed and an execution condition of the enhanced CPC is met.

In some embodiments of the present disclosure, the processor may be further configured to perform at least one of the following: performing a compliance check on the first configuration for the enhanced CPA in response to a successful CHO to the target primary cell of the master cell group; performing a compliance check on the second configuration for the enhanced CPC in response to a successful CHO to the target primary cell of the master cell group and the target primary cell of the secondary cell group; performing a compliance check on the third configuration for the enhanced CPC in response to a successful CPA procedure with the target primary cell of the secondary cell group; or performing a compliance check on the fourth configuration for the enhanced CPC in response to a successful CPC procedure with the target primary cell of the secondary cell group.

In some embodiments of the present disclosure, the processor may be further configured to perform at least one of the following: performing a first CPA procedure according to the first configuration for the enhanced CPA after a successful CHO to the target primary cell of the master cell group, and performing a compliance check on the first configuration for the enhanced CPA in response to performing the first CPA procedure; performing a second CPC procedure according to the second configuration for the enhanced CPC after a successful CHO to the target primary cell of the master cell group and the target primary cell of the secondary cell group, and performing a compliance check on the second configuration for the enhanced CPC in response to performing the second CPC procedure; performing a third CPC procedure according to the third configuration for the enhanced CPC after a successful CPA procedure with the target primary cell of the secondary cell group, and performing a compliance check on the third configuration for the enhanced CPC in response to performing the third CPC procedure; or performing a fourth CPC procedure according to the fourth configuration for the enhanced CPC after a successful CPC procedure with the target primary cell of the secondary cell group, and performing a compliance check on the fourth configuration for the enhanced CPC in response to performing the fourth CPC procedure.

In some embodiments of the present disclosure, the processor may be further configured to perform at least one of the following: in the case of a failure in the compliance check on the first configuration for the enhanced CPA, transmitting failure information to the target primary cell of the master cell group in response to a successful CHO to the target primary cell of the master cell group; in the case of a failure in the compliance check on the second configuration for the enhanced CPC, transmitting failure information to the target primary cell of the master cell group in response to a successful CHO to the target primary cell of the master cell group and the target primary cell of the secondary cell group; in the case of a failure in the compliance check on the third configuration for the enhanced CPC, transmitting failure information to the first BS or the target primary cell of the secondary cell group in response to a successful CPA procedure with the target primary cell of the secondary cell group; or in the case of a failure in the compliance check on the third configuration for the enhanced CPC, transmitting failure information to the first BS or the target primary cell of the secondary cell group in response to a successful CPC procedure with the target primary cell of the secondary cell group.

In some embodiments of the present disclosure, the failure information may indicate at least one of the following: a ID of the candidate primary cell of the secondary cell group associated with the first configuration for the enhanced CPA, the second configuration for the enhanced CPC, the third configuration for the enhanced CPC, or the fourth configuration for the enhanced CPC; or a failure type as a reconfiguration failure for enhanced CPA or CPC.

Some embodiments of the present disclosure provide a first base station (BS). The first BS may include: a transceiver; and a processor coupled to the transceiver. The processor may be configured to: transmit, to a user equipment (UE), a first radio resource control (RRC) reconfiguration message for mobility; and receive, from the UE, an RRC complete message in response to the first RRC reconfiguration message for mobility, wherein the first RRC reconfiguration message for mobility is associated with an enhanced conditional primary secondary cell (PSCell) addition (CPA) or an enhanced conditional PSCell change (CPC).

In some embodiments of the present disclosure, the processor may be further configured to transmit, to a second BS, a handover (HO) request message for a conditional HO (CHO), wherein the HO request message may indicate to prepare the enhanced CPA or the enhanced CPC.

In some embodiments, the processor may be further configured to receive, from the second BS, a HO request acknowledge message in response to the HO request message. The HO request acknowledge message may include: a first CHO configuration indicating a target primary cell of a master cell group and a first configuration for the enhanced CPA associated with a candidate primary cell of a secondary cell group, wherein the enhanced CPA is performed after the CHO is performed and an execution condition for the enhanced CPA is met; or a second CHO configuration indicating a target primary cell of a master cell group and a target primary cell of a secondary cell group and a second configuration for the enhanced CPC associated with a candidate primary cell of a secondary cell group, wherein the enhanced CPC is performed after the CHO is performed and an execution condition for the enhanced CPC is met.

In some embodiments, the first configuration for the enhanced CPA is encapsulated in the first CHO configuration or the second configuration for the enhanced CPC is encapsulated in the second CHO configuration. In some embodiments, the first configuration for the enhanced CPA is included in the HO request acknowledge message independently of the first CHO configuration or the second configuration for the enhanced CPC is included in the HO request acknowledge message independently of the second CHO configuration.

In some embodiments of the present disclosure, the processor may be further configured to transmit, to a second BS, a request message for a CPA or a CPC, wherein the request message may indicate to prepare the enhanced CPC.

In some embodiments, the request message may further indicate a BS to which a candidate PSCell of the enhanced CPC belongs.

In some embodiments, the processor may be further configured to receive, from the second BS, an acknowledge message in response to the request message. The acknowledge message may include: a third configuration for the CPA associated with a target primary cell of a secondary cell group and a third configuration for the enhanced CPC associated with a candidate primary cell of a secondary cell group, wherein the enhanced CPC is performed after the CPA is performed and an execution condition of the enhanced CPC is met; or a fourth configuration for a CPC associated with a target primary cell of a secondary cell group and a fourth configuration for the enhanced CPC associated with a candidate primary cell of a secondary cell group, wherein the enhanced CPC is performed after the CPC is performed and an execution condition of the enhanced CPC is met.

In some embodiments, the third configuration for the enhanced CPC is encapsulated in the third configuration for the CPA. In some embodiments, the fourth configuration for the enhanced CPC is encapsulated in the fourth configuration for the CPC.

In some embodiments of the present disclosure, the first RRC reconfiguration message for mobility may be encapsulated with a second RRC reconfiguration message including a configuration for the enhanced CPA or a configuration for the enhanced CPC.

In some embodiments of the present disclosure, the processor may be further configured to receive, from the UE, failure information associated with a compliance check on the enhanced CPA or enhanced CPC. In some embodiments, the failure information is received via the RRC complete message. In some embodiments, the failure information may indicate at least one of the following: a candidate primary cell of a secondary cell group associated with the enhanced CPA or enhanced CPC; or a failure type as a reconfiguration failure for enhanced CPA or CPC.

Some embodiments of the present disclosure provide a second base station (BS). The second BS may include: a transceiver; and a processor coupled to the transceiver. The processor may be configured to: receive, from a first BS, a first request message, wherein the first request message indicates to prepare an enhanced conditional primary secondary cell (PSCell) addition (CPA) or an enhanced conditional PSCell change (CPC) for a user equipment (UE); and transmit, to the first BS, a first acknowledge message in response to the first request message.

In some embodiments of the present disclosure, the first request message is a handover (HO) request message for a conditional HO (CHO).

In some embodiments, the processor may be further configured to: transmit a second request message to a third BS to indicate to prepare the enhanced CPA or the enhanced CPC associate with the CHO, wherein the enhanced CPA or the enhanced CPC is performed after the CHO is performed and an execution condition of the enhanced CPA or the enhanced CPC is met; and receive a second acknowledge message in response to the second request message, wherein the second acknowledge message includes a configuration for the enhanced CPA or the enhanced CPC.

In some embodiments, the second request message may indicate at least one of the following: an ID of the first BS; an ID of the UE; or a maximum number of enhanced CPA or CPC.

In some embodiments, transmitting the first acknowledge message may include: transmitting a configuration for the CHO and the configuration for the enhanced CPA; or transmitting a configuration for the CHO and the configuration for the enhanced CPC.

In some embodiments, the configuration for the enhanced CPA or the enhanced CPC is encapsulated in the configuration for the CHO. In some embodiments, the configuration for the enhanced CPA or the enhanced CPC and the configuration for the CHO are independently included in the first acknowledge message.

In some embodiments of the present disclosure, the first request message is a request message for a CPA or a CPC.

In some embodiments, the first request message may further indicate a BS to which a candidate PSCell of the enhanced CPC belongs.

In some embodiments, the processor may be further configured to: transmit a second request message to a third BS to indicate to prepare the enhanced CPC associate with the CPA or the CPC, wherein the enhanced CPC is performed after the CPA or the CPC is performed and an execution condition of the enhanced CPC is met; and receive a second acknowledge message in response to the second request message, wherein the second acknowledge message includes a configuration for the enhanced CPC.

In some embodiments, the second request message may indicate at least one of the following: an ID of the first BS; an ID of the UE; or a maximum number of enhanced CPC.

In some embodiments, transmitting the first acknowledge message may include: transmitting a configuration for the CPA and the configuration for the enhanced CPC; or transmitting a configuration for the CPC and the configuration for the enhanced CPC.

In some embodiments, the configuration for the enhanced CPC is encapsulated in the configuration for the CPA or CPC. In some embodiments, the configuration for the enhanced CPC and the configuration for the CPA or CPC are independently included in the first acknowledge message.

In some embodiments of the present disclosure, the processor may be further configured to: receive, from the first BS, failure information associated with a compliance check on the enhanced CPA or enhanced CPC; and transmit the failure information to a candidate PSCell associated with the enhanced CPA or enhanced CPC. In some embodiments, the failure information may indicate at least one of the following: an ID of the candidate PSCell associated with the enhanced CPA or enhanced CPC; or a failure type as a reconfiguration failure for enhanced CPA or CPC.

Some embodiments of the present disclosure provide a method performed by a user equipment (UE). The method may include: receiving, from a first base station (BS), a first radio resource control (RRC) reconfiguration message for mobility; and transmitting, to the first BS, an RRC complete message in response to receiving the first RRC reconfiguration message for mobility, wherein the first RRC reconfiguration message for mobility is associated with an enhanced conditional primary secondary cell (PSCell) addition (CPA) or an enhanced conditional PSCell change (CPC).

Some embodiments of the present disclosure provide a method performed by a first base station (BS). The method may include: transmitting, to a user equipment (UE), a first radio resource control (RRC) reconfiguration message for mobility; and receiving, from the UE, an RRC complete message in response to the first RRC reconfiguration message for mobility, wherein the first RRC reconfiguration message for mobility is associated with an enhanced conditional primary secondary cell (PSCell) addition (CPA) or an enhanced conditional PSCell change (CPC).

Some embodiments of the present disclosure provide a method performed by a second base station (BS). The method may include: receiving, from a first BS, a first request message, wherein the first request message indicates to prepare an enhanced conditional primary secondary cell (PSCell) addition (CPA) or an enhanced conditional PSCell change (CPC) for a user equipment (UE); and transmitting, to the first BS, a first acknowledge message in response to the first request message.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a flow chart of an exemplary procedure for secondary node (SN) addition in accordance with some embodiments of the present disclosure;

FIG. 3 illustrates a flow chart of an exemplary procedure of SN change in accordance with some embodiments of the present disclosure;

FIGS. 4-6 illustrate a flow chart of an exemplary procedure of wireless communications in accordance with some embodiments of the present disclosure;

FIGS. 7-9 illustrate a flow chart of an exemplary procedure of UE mobility in accordance with some embodiments of the present disclosure; and

FIG. 10 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

In some embodiments of the present disclosure, a wireless communication system may support a multi-radio dual connectivity (MR-DC) operation. In a MR-DC scenario, a UE may be configured with multiple transceivers and may be configured to utilize resources provided by two different nodes (e.g., two BSs). In some examples, one node may provide new radio (NR) access and the other one node may provide either evolved-universal mobile telecommunication system (UMTS) terrestrial radio access (UTRA) (E-UTRA) or NR access. One node may act as a master node (MN) and the other node may act as a secondary node (SN). The MN and SN are connected via a network interface (for example, the Xn interface as specified in 3GPP specifications), and at least the MN may be connected to the core network.

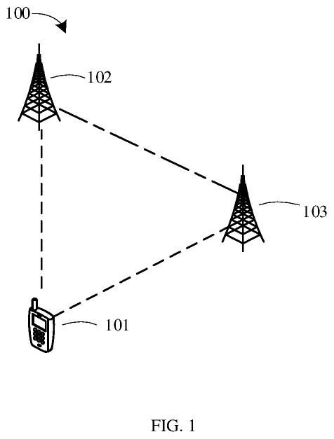

FIG. 1 illustrates a schematic diagram of wireless communication system 100 in accordance with some embodiments of the present disclosure. As shown in FIG. 1, wireless communication system 100 may be a dual connectivity system, and may include at least one UE (e.g., UE 101) and some base stations (e.g., BS 102 acting as a master node (MN), and BS 103 acting as an SN). Although a specific number of UEs and BSs is depicted in FIG. 1, it is contemplated that any number of UEs and BSs (e.g., MNs or SNs) may be included in wireless communication system 100.

Referring to FIG. 1, UE 101 may be connected to BS 102 and BS 103 via a network interface, for example, the Uu interface as specified in 3GPP standard documents. The link established between a UE (e.g., UE 101) and a BS (e.g., BS 102) may be referred to as a Uu link. BS 102 and BS 103 may be connected to each other via a network interface, for example, the Xn interface as specified in 3GPP standard documents. In some examples, BS 102 may be connected to the core network via a network interface (not shown in FIG. 1). UE 102 may be configured to utilize resources provided by BS 102 and BS 103 to perform transmissions.

In some embodiments of the present disclosure, BS 102 may refer to a radio access node that provides a control plane connection to the core network. In some embodiments, in the E-UTRA-NR dual connectivity (EN-DC) scenario, BS 102 may be an eNB. In some embodiments, in the next generation (NG) E-UTRA-NR dual connectivity (NGEN-DC) scenario, BS 102 may be an ng-eNB. In some embodiments, in the NR-E-UTRA dual connectivity (NE-DC) scenario or the NR-NR dual connectivity (NR-DC) scenario, BS 102 may be a gNB.

BS 102 (e.g., MN) may be associated with a master cell group (MCG). The MCG may refer to a group of serving cells associated with BS 102, and may include a primary cell (PCell) and optionally one or more secondary cells (SCells) of the MCG. The PCell may provide a control plane connection to UE 101.

In some embodiments of the present disclosure, BS 103 may refer to a radio access node without a control plane connection to the core network, but providing additional resources to UE 101. In some embodiments, in the EN-DC scenario, BS 103 may be an en-gNB. In some embodiments, in the NE-DC scenario, BS 103 may be an ng-eNB. In some embodiments, in the NR-DC scenario or the NGEN-DC scenario, BS 103 may be a gNB.

BS 103 (e.g., SN) may be associated with a secondary cell group (SCG). The SCG may refer to a group of serving cells associated with BS 103, and may include a primary secondary cell (PSCell) and optionally one or more secondary cells (SCells). The PCell of the MCG and the PSCell of the SCG may also be referred to as a special cell (SpCell).

In some embodiments of the present disclosure, UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some embodiments of the present disclosure, UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some embodiments of the present disclosure, UE 101 may include wearable devices, such as smart watches, fitness bands, optical head-mounted displays, or the like. In some embodiments of the present disclosure, UE 101 may include, for example, but is not limited to, an internet of things (IoT) device or a vehicle. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art. Persons skilled in the art should understand that as technology develops and advances, the terminologies described in the present disclosure may change, but should not affect or limit the principles and spirit of the present disclosure.

In some embodiments, a BS (functioning as an MN) may initiate an SN addition procedure to establish a UE context at an SN, so as to provide resources from the SN to a UE served by the MN. In some embodiments, for bearers requiring SCG radio resources, an SN addition procedure may be used to add at least an initial SCG serving cell of the SCG. In some embodiments, an SN addition procedure may also be used to configure an SN terminated MCG bearer (e.g., where no SCG configuration is needed).

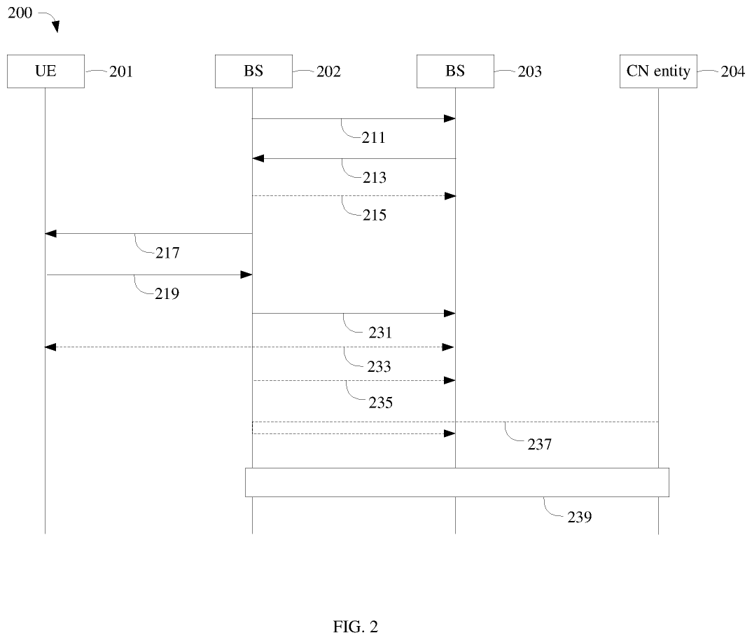

FIG. 2 illustrates a flow chart of exemplary procedure 200 for secondary node (SN) addition in accordance with some embodiments of the present disclosure. Details described in all of the foregoing embodiments of the present disclosure are applicable for the embodiments shown in FIG. 2.

In FIG. 2, UE 201, BS 202, BS 203 may function as UE 101, BS 102, and BS 103 shown in FIG. 1, respectively. At the beginning, UE 201 may be connected to BS 202. BS 202 (i.e., functioning as an MN) may initiate an SN addition procedure to establish a UE context at BS 203 (e.g., functioning as an SN).

For example, BS 202 may decide to request a target SN (e.g., BS 203) to allocate resources for one or more specific protocol data unit (PDR) sessions/quality of service (QoS) flows, indicating QoS Flows characteristics (e.g., QoS flow level QoS parameters, PDU session level transport network layer (TNL) address information, and PDU session level network slice information). Thus, in operation 211, BS 202 may transmit an SN addition request message to BS 203 (e.g., SN). For bearers requiring SCG radio resources, BS 202 may further indicate the requested SCG configuration information, including, for example, the entire UE capabilities and the UE capability coordination results. In this case, BS 202 may also provide the latest measurement results for BS 203 to choose and configure the SCG cell(s). BS 202 may request BS 203 to allocate radio resources for a split signaling radio bearer (SRB) operation. In some embodiments, in the NGEN-DC and NR-DC scenarios, BS 202 may always provide all the needed security information to BS 203 (even if no SN terminated bearers are set up) to enable SRB3 to be set up based on the SN decision.

In response to the SN addition request message, BS 203 may transmit an SN addition request acknowledgement message to BS 202 in operation 213. For example, if the radio resource management (RRM) entity in BS 203 is able to admit the resource request, it allocates respective radio resources and, dependent on the bearer type options, respective transport network resources. For bearers requiring SCG radio resources, BS 203 may trigger a UE random access so that synchronization of the SN radio resource configuration can be performed. BS 203 may decide for the PSCell and other SCells for the SCG, and provide the new SCG radio resource configuration to BS 202 within an SCG RRC configuration message contained in the SN addition request acknowledgement message. If SCG radio resources have been requested, the SCG radio resource configuration may be provided.

In some examples, for SN terminated bearers using MCG resources, BS 203 may provide Xn-U DL TNL address information via an Xn-U address indication message in operation 215 (denoted by a dotted arrow as an option).

In response to receiving the SN addition request acknowledgement message, BS 202 may transmit an RRC reconfiguration message (e.g., MN RRC reconfiguration message) to UE 201 in operation 217. The RRC reconfiguration message may include the SCG RRC configuration message, without modification.

UE 201 may apply the new configuration and reply to BS 202 with an RRC reconfiguration complete message (e.g., MN RRC reconfiguration complete message) in operation 219. The RC reconfiguration complete message may include an SN RRC response message for BS 203 (SN), if needed. In some examples, in the case that UE 201 is unable to comply with (all or part of) the configuration included in the RRC reconfiguration message (e.g., MN RRC reconfiguration message), UE 201 may perform the reconfiguration failure procedure.

In response to receiving the RRC reconfiguration complete message, BS 202 may inform BS 203 (SN) that the UE has completed the reconfiguration procedure successfully via an SN reconfiguration complete message in operation 231. The SN reconfiguration complete message may include the SN RRC response message, if received from UE 201.

In some embodiments, if configured with bearers requiring SCG radio resources, UE 201 may perform synchronization towards the PSCell configured by BS 203 (SN). For example, UE 201 may perform a random access procedure with the configured PSCell in operation 233 (denoted by a dotted arrow as an option). It should be appreciated that the present disclosure does not limit the order a UE 201 transmits the MN RRC reconfiguration complete message and performs the random access procedure towards the SCG. The successful random access procedure towards the SCG is not required for a successful completion of the RRC connection reconfiguration procedure.

In some embodiments, if packet data convergence protocol (PDCP) termination point is changed to the SN for bearers using radio link control (RLC) acknowledge mode (AM), and when RRC full configuration is not used, BS 202 (MN) may transmit the SN status transfer to BS 203 (SN) in operation 235 (denoted by a dotted arrow as an option). In some embodiments, for SN terminated bearers or QoS flows moved from the MN, dependent on the characteristics of the respective bearer or QoS flow, BS 202 (MN) may take actions to minimize service interruption due to the activation of MR-DC. For example, data forwarding may be performed in operation 237 (denoted by a dotted arrow as an option). For instance, data from CN entity 204 (e.g., user plane function (UPF)) may be forwarded to BS 203 (SN) via BS 202 (MN). In some embodiments, if applicable, the update of the user plane (UP) path towards the 5G core (5GC) may be performed via a PDU session path update procedure in operation 239.

It should be appreciated by persons skilled in the art that the sequence of the operations in exemplary procedure 200 may be changed and some of the operations in exemplary procedure 200 may be eliminated or modified, without departing from the spirit and scope of the disclosure.

In some embodiments, an SN change procedure may be performed to, for example, transfer a UE context from a source SN to a target SN and change the SCG configuration in a UE from one SN to another. The SN change procedure may always involve signaling over an MCG SRB towards the UE. The SN change procedure may be initiated by an MN or an SN (source SN).

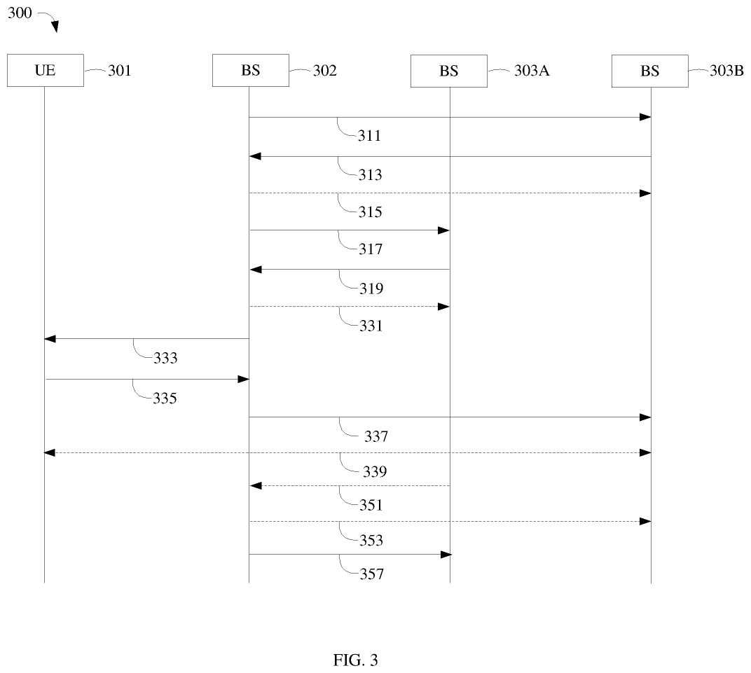

FIG. 3 illustrates a flow chart of exemplary procedure 300 for SN change initiated by an MN in accordance with some embodiments of the present disclosure. Details described in all of the foregoing embodiments of the present disclosure are applicable for the embodiments shown in FIG. 3.

In FIG. 3, UE 301, BS 302, BS 303 may function as UE 101, BS 102, and BS 103 shown in FIG. 1, respectively. At the beginning, UE 301 may be connected to both BS 302 and BS 303A, which respectively functions as an MN and an SN. BS 302 (MN) may initiate the SN change by requesting a target SN (e.g., BS 303B) to allocate resources for UE 301 by means of the SN addition procedure.

For example, in operation 311, BS 302 may transmit an SN addition request message to BS 303B. BS 302 may include measurement results related to BS 303B. In operation 313, BS 303B may transmit an SN addition request acknowledgement message to BS 303B in response to the SN addition request message. If data forwarding is needed, BS 303B may provide data forwarding addresses to BS 302. BS 303B may include the indication of the full or delta RRC configuration.

In some embodiments, BS 302 may trigger an MN-initiated SN modification procedure (to the source SN) to retrieve the current SCG configuration and to allow for the provision of data forwarding related information before operation 311.

In some embodiments, for SN terminated bearers using MCG resources, BS 302 may provide Xn-U DL TNL address information in an Xn-U address indication message in operation 315 (denoted by a dotted arrow as an option).

In some embodiments, descriptions with respect to operations 211-215 in FIG. 2 may be similarly applied to operations 311-315 in FIG. 3.

If the allocation of target SN resources was successful, BS 302 may initiate the release of the source SN resources. For example, in operation 317 (denoted by a dotted arrow as an option), BS 302 may transmit an SN release request message to BS 303A (source SN). The SN release request may include a cause indicating SCG mobility. In operation 319 (denoted by a dotted arrow as an option), BS 303A may transmit an SN release request acknowledgement message to BS 303A (source SN) as a response. In some cases, BS 303A may reject the release.

In some embodiments, if data forwarding is needed, BS 302 may provide data forwarding addresses to BS 303A (source SN) in operation 331 (denoted by a dotted arrow as an option). If direct data forwarding is used for SN terminated bearers, BS 302 may provide data forwarding addresses as received from BS 303B (target SN) to BS 303A (source SN). In some embodiments, reception of the SN release request message may trigger BS 303A to stop providing user data to UE 301.

BS 302 may trigger UE 301 to apply the new configuration. For example, in operation 333, BS 302 may indicate the new configuration to UE 301 in, for example, an MN RRC reconfiguration message including the target SN RRC reconfiguration message. UE 301 may apply the new configuration and transmit, in operation 335, an MN RRC reconfiguration complete message, including an SN RRC response message for BS 303B, if needed. In the case that UE 301 is unable to comply with (all or part of) the configuration included in the MN RRC reconfiguration message, UE 301 may perform the reconfiguration failure procedure.

If the RRC connection reconfiguration procedure was successful, BS 302 may, in operation 337, inform BS 303B via an SN reconfiguration complete message with the included SN RRC response message for BS 303B, if received from UE 301.

In some embodiments, if configured with bearers requiring SCG radio resources, UE 301 may synchronize with BS 303B. For example, in operation 339 (denoted by a dotted arrow as an option), UE 301 may perform a random access procedure with BS 303B.

In some embodiments, if a PDCP termination point is changed for bearers using RLC AM, BS 303A may, in operation 351 (denoted by a dotted arrow as an option), transmit an SN status transfer to BS 302, and BS 302 may, in operation 353 (denoted by a dotted arrow as an option), transmit the received SN status transfer to BS 303B, if needed.

In some embodiments, if applicable, data forwarding from BS 303A (source SN) may take place (not shown in FIG. 3). It may be initiated as early as BS 303A receives the SN Release Request message from BS 302.

In some embodiments, BS 303A (source SN) may transmit a secondary radio access technology (RAT) data usage report message to BS 302 and include the data volumes delivered to and received from UE 301.

In some embodiments, if applicable, BS 302 may trigger a PDU session path update procedure.

In operation 357, in response to receiving the UE context release message, BS 303A (source SN) may release radio and C-plane related resources associated with the UE context. Any ongoing data forwarding may continue.

It should be appreciated by persons skilled in the art that the sequence of the operations in exemplary procedure 300 may be changed and some of the operations in exemplary procedure 300 may be eliminated or modified, without departing from the spirit and scope of the disclosure.

A conditional handover (CHO) is defined as a handover executed by a UE when one or more handover execution conditions are met. The UE may start evaluating the execution condition(s) in response to receiving the CHO configuration, and stop evaluating the execution condition during the CHO execution when the execution condition(s) is met.

In some embodiments, at least one of the following principles may apply to a CHO.
The CHO configuration may include the configuration of a CHO candidate cell(s) generated by the candidate BS(s) and execution condition(s) generated by the source BS.
An execution condition may include one or two trigger condition(s) (e.g., A3/A5, as defined in 3GPP specifications). Only a single reference single (RS) type may be supported and at most two different execution quantities (e.g., reference signal receiving power (RSRP) and reference signal receiving quality (RSRQ), RSRP and signal to interference plus noise ratio (SINR), etc.) can be configured simultaneously for the evaluation of CHO execution condition of a single candidate cell.
Before any CHO execution condition is satisfied, in response to the reception of a handover command (without CHO configuration, and also referred to an “ordinary HO”), the UE may execute the HO procedure, regardless of any previously received CHO configuration.
While executing a CHO, e.g., from the time when the UE starts synchronization with a target cell, the UE may not monitor the source cell.

A conditional PSCell Addition (CPA) is defined as a PSCell addition executed by a UE when an execution condition(s) is met. The UE may start evaluating the execution condition(s) in response to receiving the CPA configuration, and stop evaluating the execution condition(s) when the PSCell addition is triggered. A CPA configuration may include the configuration of a CPA candidate PSCell(s) and an execution condition(s) generated by an MN.

A conditional PSCell change (CPC) is defined as a PSCell change executed by a UE when an execution condition(s) is met. The UE may start evaluating the execution condition(s) in response to receiving the CPC configuration, and stop evaluating the execution condition(s) when the PSCell change is triggered. A CPC configuration may include the configuration of a CPC candidate PSCell(s) and an execution condition(s) generated by an SN or an MN (e.g., the one configures the CPC for the UE).

In some embodiments, an execution condition may include one or two trigger condition(s) (e.g., CPC events A3/A5, as defined in 3GPP specifications). In some embodiments, only a single reference single (RS) type may be supported and at most two different trigger quantities (e.g., RSRP and RSRQ, RSRP and SINR, etc.) can be configured simultaneously for the evaluation of the CPC execution condition of a single candidate PSCell.

In some cases, the procedure for the CPC may also be referred to as an SN change.

In some embodiments, an ordinary HO, CHO, a CPA or a CPC may be embedded with a CPA or a CPC. Such embedded CPA or CPC may also be referred to as an enhanced CPA or CPC. For example, when a UE is configured with a CHO, CPA or CPC with an enhanced CPA or CPC, the UE may perform the CHO, CPA or CPC when the corresponding execution condition for the CHO, CPA or CPC is satisfied. The UE may perform the enhanced CPA or CPC after the CHO, CPA or CPC is performed when the execution condition for the enhanced CPA or CPC is satisfied. For example, when a UE is configured with an ordinary HO with an enhanced CPA or CPC, the UE may perform the ordinary HO in response to receiving the corresponding RRC reconfiguration message and switch to the target BS(s). The UE may perform the enhanced CPA or CPC after the ordinary HO is performed when the execution condition for the enhanced CPA or CPC is satisfied.

In some cases, a CHO configuration may indicate a target MCG (e.g., a target primary cell of the MCG) and an enhanced CPA associated with a candidate SCG (e.g., a candidate primary cell of the SCG). A UE may switch to the target primary cell of the MCG (denoted as cell #1A) when the corresponding CHO execution condition is met, and may perform the enhanced CPA (e.g., access to the candidate primary cell of the SCG while maintain the connection with cell #1A) after the UE switch to cell #1A and the execution condition of the enhanced CPA is met.

In some cases, a CHO configuration may indicate a target MCG (e.g., a target primary cell of the MCG) and a target SCG (e.g., a target primary cell of the SCG) and an enhanced CPC associated with a candidate SCG (e.g., a candidate primary cell of the SCG). A UE may switch to the target primary cell of the MCG (denoted as cell #1B) and the target primary cell of the SCG (denoted as cell #2B) when the corresponding CHO execution condition is met, and may perform the enhanced CPC (e.g., switch from cell #2B to the candidate primary cell of the candidate SCG while maintain the connection with cell #1B) after the UE switch to cell #1B and cell #2B and the execution condition of the enhanced CPC is met.

Similar to the above cases for the CHO, an ordinary HO may include an enhanced CPA or CPC, except that, for example, the execution of the ordinary HO does not involve an evaluation of the execution condition for the CHO.

In some cases, a CPA or a CPC configuration may indicate a target SCG (e.g., a target primary cell of the SCG) and an enhanced CPC associated with a candidate SCG (e.g., a candidate primary cell of the SCG). A UE may access (in the case of CPA) or switch to (in the case of CPC) the target primary cell of the SCG (denoted as cell #1C) when the corresponding execution condition for the CPA or CPC is met and may perform the enhanced CPC (e.g., switch from cell #1C to the candidate primary cell of the candidate SCG) after the UE performs the CPA or CPC and the execution condition of the enhanced CPC is met.

A compliance check on the mobility configuration may be necessary since a UE may be unable to comply with (all or part of) the configuration. When a failure in the compliance check occurs, a remedy action may be required.

In some embodiments, a UE may perform a compliance check on an RRC reconfiguration message for a CHO or CPC in response to the reception of the message or in response to the execution of the CHO or CPC (when the message is required to be applied). If the UE is unable to comply with (all or part of) the configuration included in the RRC reconfiguration message, the UE may use the configuration used prior to when the inability to comply with the RRC reconfiguration message was detected. The UE may initiate a re-establishment procedure or SCG failure information procedure.

However, various issues may occur when an RRC reconfiguration message for mobility (e.g., ordinary HO, CHO, CPA or CPC) with enhanced CPA or CPC is configured for a UE. For example, the impact on the mobility configuration procedure when the enhanced CPA or CPC is introduced, how to perform the compliance check, and the UE behavior in response to a failure on the compliance check failure. Solutions are proposed to solve at least the above-mentioned issues. More details on the embodiments of the present disclosure will be illustrated in the following text in combination with the appended drawings.

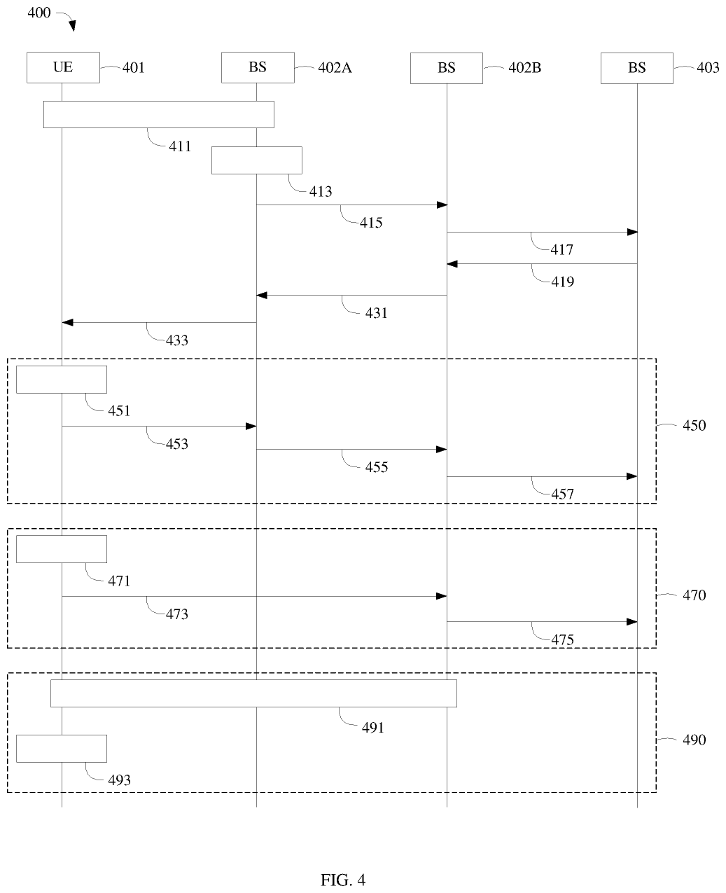

FIG. 4 illustrates a flow chart of exemplary procedure 400 for wireless communications in accordance with some embodiments of the present disclosure. Details described in all of the foregoing embodiments of the present disclosure are applicable for the embodiments shown in FIG. 4.

Referring to FIG. 4, in operation 411, UE 401 may be in a connected state (e.g., RRC_CONNECTED state as specified in 3GPP specifications) and may access its serving cell (e.g., BS 402A). In some embodiments, UE 401 may report its UE capability to the serving cell (e.g., BS 402A). The UE capability may include at least one of the following:
whether to support an enhanced CPA or CPC embedded in an ordinary HO configuration;
whether to support an enhanced CPA or CPC embedded in a CHO configuration;
whether to support an enhanced CPC embedded in a CPA or CPC configuration;
the maximum number of enhanced CPAs or CPCs that can be embedded in each ordinary HO configuration;
the maximum number of enhanced CPAs or CPCs that can be embedded in each CHO configuration;
the maximum number of enhanced CPCs that can be embedded in each CPA or CPC configuration; or
the maximum number of enhanced CPAs and/or CPCs that can be embedded in a conditional reconfiguration (e.g., CHO, CPA, or CPC configuration).

UE 401 may transmit measurement reports to the serving cell (e.g., BS 402A).

In operation 413, BS 402A (source BS) may determine to switch UE 401 to another BS (target BS, such as BS 402B) via a CHO based on, for example, the measurement results. In operation 415, BS 402A may transmit a handover request message (e.g., a CHO request message) to BS 402B. In some embodiments, BS 402A may indicate BS 402B to prepare an enhanced CPA. For example, the handover request message may indicate (e.g., by including an indicator) to prepare the enhanced CPA. The enhanced CPA may be performed after the CHO is performed and an execution condition of the enhanced CPA is met.

In some embodiments, BS 402A may indicate the maximum number of enhanced CPAs (e.g., the maximum number of candidate SCGs for the enhanced CPA or the maximum number of candidate primary cells of an SCG for the enhanced CPA) that is allowed. The maximum number of enhanced CPAs can be per a target BS for CHO or per a candidate SN.

In response to receiving the handover request message, BS 402B may prepare a CHO configuration, which may indicate a target primary cell of an MCG. In operation 417, BS 402B (acting as target MN) may transmit an SN addition request message to an SN (e.g., BS 403) via the Xn interface. In some embodiments, the SN addition request message may indicate (e.g., by including an indicator) to prepare the enhanced CPA associated with the CHO.

In some embodiments, the SN addition request message may further indicate at least one of: an ID of BS 402A (source MN), an ID of UE 401, or the maximum number of enhanced CPAs (e.g., the maximum number of candidate SCGs for the enhanced CPA or the maximum number of candidate primary cells of an SCG for the enhanced CPA). In some examples, the maximum number of enhanced CPAs can be per candidate SN (e.g., BS 403). In some examples, the UE ID may be a Source M-NG-RAN node UE XnAP ID. By including the UE ID, a candidate SN (e.g., BS 403) may consider that the SN addition preparation procedures that have been triggered for CPA as part of a CHO. For example, the candidate SN may use the Source M-NG-RAN node ID information element (IE) and the UE ID (e.g., Source M-NG-RAN node UE XnAP ID IE) to identify other active SN node addition preparations related to a specific UE (e.g., UE 401) for CPA.

In operation 419, BS 403 (candidate SN) may transmit an SN addition request acknowledgement message to BS 402B. The SN addition request acknowledgement message may include the configuration for the enhanced CPA (e.g., a configuration associated with a candidate primary cell of an SCG). In response to receiving the SN addition request acknowledgement message, BS 402B may add the execution condition(s) for the enhanced CPA.

In operation 431, BS 402B may transmit a handover request acknowledgement message to BS 402A. The handover request acknowledgement message may include the CHO configuration and the configuration for the enhanced CPA.

In some embodiments, the configuration for the enhanced CPA may be embedded in the CHO configuration. For example, the CHO configuration and the configuration for the enhanced CPA may be included in respective RRC reconfiguration messages (e.g., message #1 and message #2, respectively). Message #2 may be encapsulated (e.g., as a container) in message #1.

In some embodiments, the CHO configuration and the configuration for the enhanced CPA may be independently included in the handover request acknowledgement message. For example, the CHO configuration and the configuration for the enhanced CPA may be arranged in parallel in the handover request acknowledgement message. For example, the handover request acknowledgement message may include message #1 and message #2 in a parallel arrangement.

In operation 433, BS 402A may transmit the CHO configuration and the configuration for the enhanced CPA to UE 401. For example, BS 402A may transmit an RRC reconfiguration message for mobility to UE 401.

In some embodiments, the configuration for the enhanced CPA may be embedded in the CHO configuration in the RRC reconfiguration message for mobility. For example, the configuration for the enhanced CPA may be included in an RRC reconfiguration message, which may be encapsulated (e.g., as a container) in the RRC reconfiguration message for mobility.

In some embodiments, the CHO configuration and the configuration for the enhanced CPA may be independently included in the RRC reconfiguration message for mobility. For example, the CHO configuration and the configuration for the enhanced CPA may be arranged in parallel in the RRC reconfiguration message for mobility.

UE 401 may perform a compliance check on the RRC reconfiguration message for mobility. In some embodiments, UE 401 may perform a compliance check in response to the reception of the RRC reconfiguration message for mobility. An exemplary procedure is shown in procedure 450 in FIG. 4. In some embodiments, UE 401 may perform a compliance check in response to performing the CHO procedure. An exemplary procedure is shown in procedure 470 in FIG. 4. In some embodiments, UE 401 may perform a compliance check on the configuration of the enhanced CPA at another timing. An exemplary procedure is shown in procedure 490 in FIG. 4.

According to procedure 450, in operation 451, UE 401 may perform a compliance check on the configuration of the enhanced CPA in response to the reception of the RRC reconfiguration message for mobility. In response to a failure in the compliance check, UE 401 may transmit failure information to BS 402A (source BS) in operation 453. BS 402A may transmit the failure information to BS 402B (target BS, acting as an MN) in operation 455. BS 402B may transmit the failure information to BS 403 (SN associated with the enhanced CPA) in operation 457.

According to procedure 470, in operation 471, UE 401 may perform a compliance check on the configuration of the enhanced CPA in response to performing the CHO procedure. For example, UE 401 may perform a CHO procedure to the target primary cell of the MSG (e.g., BS 402B) according to the CHO configuration in response to the corresponding execution condition being met. UE 401 may perform a compliance check on the configuration for the enhanced CPA in response to performing the CHO procedure. In the case of a failure in the compliance check, UE 401 may transmit failure information to BS 402B (target BS) in operation 473, in response to the CHO being successfully performed. BS 402B may transmit the failure information to BS 403 (SN associated with the enhanced CPA) in operation 475.

In some embodiments, in procedures 450 and 470, the failure information may be included in an RRC complete message. For example, in response to receiving the RRC reconfiguration message for mobility, UE 401 may transmit an RRC complete message to BS 402A. For example, in response to the CHO being successfully performed, UE 401 may transmit an RRC complete message to BS 402B.

In some embodiments, in procedures 450 and 470, UE 401 may release the configuration for the enhanced CPA in response to the failure in the compliance check.

In some embodiments, in procedures 450 and 470, the failure information may indicate at least one of the following: a candidate PSCell (e.g., by indicating the cell ID) associated with the configuration for the enhanced CPA (e.g., the candidate primary cell of the SCG indicated in this configuration) or a failure type as a reconfiguration failure for enhanced CPA. In the case that a plurality of enhanced CPAs is configured, indicating the candidate PSCell can differentiate which enhanced CPA(s) involves the compliance failure.

According to procedure 490, UE 401 may perform a compliance check on the CHO configuration in response to the reception of the RRC reconfiguration message for mobility or in response to performing the CHO procedure. However, UE 401 may not perform a compliance check on the configuration for the enhanced CPA at the above two timings. In operation 491, UE 401 may perform a CHO procedure to the target primary cell of the MSG (e.g., BS 402B) according to the CHO configuration in response to the corresponding execution condition being met and may successfully perform the CHO.

After the successful CHO, UE 401 may perform the enhanced CPA when the execution condition for the enhanced CPA is met. For example, UE 401 may be connected to the candidate primary cell of the SCG (e.g., BS 403) according to the enhanced CPA while maintain the connection with the target primary cell of the MSG (e.g., BS 402B). That is, after the enhanced CPA, UE 401 may be connected to both BS 402B (MN) and BS 403 (SN).

In some embodiments, UE 401 may, in operation 493, perform a compliance check on the configuration for the enhanced CPA in response to the successful CHO or in response to performing the enhanced CPA.

In some embodiments, in response to a failure in the compliance check on the configuration for the enhanced CPA, UE 401 may perform a remedy action. For example, UE 401 may perform a recovery procedure, which may be a re-establishment procedure or SCG failure information procedure.

In some embodiments, in response to a failure in the compliance check on the configuration for the enhanced CPA, UE 401 may transmit failure information to BS 402B (e.g., the target primary cell of the MCG associated with the CHO). BS 402B may transmit the failure information to BS 403 (SN associated with the enhanced CPA).

In some embodiments, the failure information may indicate at least one of the following: a candidate PSCell (e.g., by indicating the cell ID) associated with the configuration for the enhanced CPA (e.g., the candidate primary cell of the SCG indicated in this configuration) or a failure type as a reconfiguration failure for enhanced CPA. In the case that a plurality of enhanced CPAs is configured, indicating the candidate PSCell can differentiate which enhanced CPA(s) involves the compliance failure.

In exemplary procedure 400, UE 401 may perform a compliance check on the CHO configuration in response to the reception of the RRC reconfiguration message for mobility or in response to performing the CHO procedure. UE 401 may perform a remedy action in the case of a failure in the compliance check on the CHO configuration. When UE 401 performs a compliance check on the configuration for the enhanced CPA in response to the reception of the RRC reconfiguration message for mobility or in response to performing the CHO procedure, UE 401 may not perform the remedy action in the case that the compliance check on the CHO configuration is successful but the compliance check on the configuration for the enhanced CPA fails. When UE 401 performs a compliance check on the configuration for the enhanced CPA in response to the successful CHO or in response to performing the enhanced CPA, UE 401 may perform the remedy action in the case that the compliance check on the configuration for the enhanced CPA fails.

It should be appreciated by persons skilled in the art that although the above descriptions with respect to FIG. 4 are described with respect to a CHO, the descriptions can be similarly applied to an ordinary HO, except that, for example, the execution of the ordinary HO does not involve an evaluation of the execution condition for the CHO. For example, in response to receiving the handover request message (e.g., an HO request message), BS 402B may prepare an ordinary HO configuration, instead of a CHO configuration. For example, in response to receiving the RRC reconfiguration message for mobility, UE 401 may perform an ordinary HO.

It should be appreciated by persons skilled in the art that the sequence of the operations in exemplary procedure 400 may be changed and that some of the operations in exemplary procedure 400 may be eliminated or modified, without departing from the spirit and scope of the disclosure.

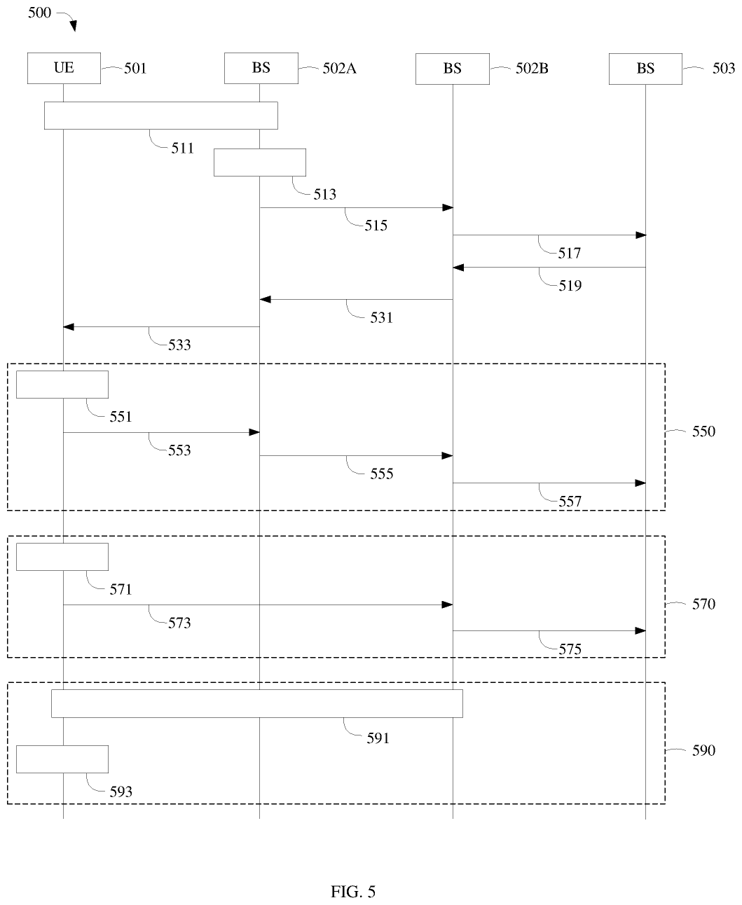

FIG. 5 illustrates a flow chart of exemplary procedure 500 for wireless communications in accordance with some embodiments of the present disclosure. Details described in all of the foregoing embodiments of the present disclosure are applicable for the embodiments shown in FIG. 5.

Referring to FIG. 5, in operation 511, UE 501 may be in a connected state (e.g., RRC_CONNECTED state as specified in 3GPP specifications) and may access its serving cell (e.g., BS 502A). In some embodiments, UE 501 may report its UE capability to the serving cell (e.g., BS 502A). The UE capability may include at least one of the following:
whether to support an enhanced CPA or CPC embedded in an ordinary HO configuration;
whether to support an enhanced CPA or CPC embedded in a CHO configuration;
whether to support an enhanced CPC embedded in a CPA or CPC configuration;
the maximum number of enhanced CPAs or CPCs that can be embedded in each ordinary HO configuration;
the maximum number of enhanced CPAs or CPCs that can be embedded in each CHO configuration;
the maximum number of enhanced CPCs that can be embedded in each CPA or CPC configuration; or
the maximum number of enhanced CPAs and/or CPCs that can be embedded in a conditional reconfiguration (e.g., CHO, CPA, or CPC configuration).

UE 501 may transmit measurement reports to the serving cell (e.g., BS 502A).

In operation 513, BS 502A (source BS) may determine to switch UE 501 to a target BS acting as an MN (e.g., BS 502B) and another target BS acting as an SN via a CHO based on, for example, the measurement results. In operation 515, BS 502A may transmit a handover request message (e.g., a CHO request message) to BS 502B. In some embodiments, BS 502A may indicate BS 502B to prepare an enhanced CPC. For example, the handover request message may indicate (e.g., by including an indicator) to prepare the enhanced CPC. The enhanced CPC may be performed after the CHO is performed and an execution condition of the enhanced CPC is met.

In some embodiments, BS 502A may indicate the maximum number of enhanced CPCs (e.g., the maximum number of candidate SCGs for the enhanced CPC or the maximum number of candidate primary cells of an SCG for the enhanced CPC) that is allowed. The maximum number of enhanced CPCs can be per a target BS for CHO or per a candidate SN.

In response to receiving the handover request message, BS 502B may prepare a CHO configuration, which may indicate a target primary cell of an MCG (e.g., BS 502B) and a target primary cell of an SCG (e.g., target SN).

In some embodiments, in operation 517, BS 502B (acting as target MN) may transmit a request message to a candidate SN (e.g., BS 503) via the Xn interface. In some embodiments, the request message may indicate (e.g., by including an indicator) to prepare the enhanced CPC associated with the CHO.

In some examples, the candidate SN may be the target SN of the CHO. The request message may be an SN modification request message. In some examples, the candidate SN may be a BS different from the target SN of the CHO. The request message may be an SN addition request message.

In some embodiments, the request message may further indicate at least one of: an ID of BS 502A (source MN), an ID of UE 501, or the maximum number of enhanced CPCs (e.g., the maximum number of candidate SCGs for the enhanced CPC or the maximum number of candidate primary cells of an SCG for the enhanced CPC). In some examples, the maximum number of enhanced CPCs can be per candidate SN (e.g., BS 503). In some examples, the UE ID may be a Source M-NG-RAN node UE XnAP ID. By including the UE ID, a candidate SN (e.g., BS 503) may consider that the SN addition preparation procedures that have been triggered for CPC as part of a CHO. For example, the candidate SN may use the Source M-NG-RAN node ID IE and the UE ID (e.g., Source M-NG-RAN node UE XnAP ID IE) to identify other active SN node addition preparations related to a specific UE (e.g., UE 501) for CPC.

In operation 519, BS 503 (candidate SN, which may different from or the same as the target SN of the CHO) may transmit an acknowledgement message (e.g., an SN addition request acknowledgement message or an SN modification request acknowledgement message) to BS 502B. The acknowledgement message may include the configuration for the enhanced CPC (e.g., a configuration associated with a candidate primary cell of an SCG). In response to receiving the acknowledgement message, BS 502B may add the execution condition(s) for the enhanced CPC.

In operation 531, BS 502B may transmit a handover request acknowledgement message to BS 502A. The handover request acknowledgement message may include the CHO configuration and the configuration for the enhanced CPC.

In some embodiments, the configuration for the enhanced CPC may be embedded in the CHO configuration. For example, the CHO configuration and the configuration for the enhanced CPC may be included in respective RRC reconfiguration messages (e.g., message #1′ and message #2′, respectively). Message #2′ may be encapsulated (e.g., as a container) in message #1′.

In some embodiments, the CHO configuration and the configuration for the enhanced CPC may be independently included in the handover request acknowledgement message. For example, the CHO configuration and the configuration for the enhanced CPC may be arranged in parallel in the handover request acknowledgement message. For example, the handover request acknowledgement message may include message #1′ and message #2′ in a parallel arrangement.

In operation 533, BS 502A may transmit the CHO configuration and the configuration for the enhanced CPC to UE 501. For example, BS 502A may transmit an RRC reconfiguration message for mobility to UE 501.

In some embodiments, the configuration for the enhanced CPC may be embedded in the CHO configuration in the RRC reconfiguration message for mobility. For example, the configuration for the enhanced CPC may be included in an RRC reconfiguration message, which may be encapsulated (e.g., as a container) in the RRC reconfiguration message for mobility.

In some embodiments, the CHO configuration and the configuration for the enhanced CPC may be independently included in the RRC reconfiguration message for mobility. For example, the CHO configuration and the configuration for the enhanced CPC may be arranged in parallel in the RRC reconfiguration message for mobility.

UE 501 may perform a compliance check on the RRC reconfiguration message for mobility. In some embodiments, UE 501 may perform a compliance check in response to the reception of the RRC reconfiguration message for mobility. An exemplary procedure is shown in procedure 550 in FIG. 5. In some embodiments, UE 501 may perform a compliance check in response to performing the CHO procedure. An exemplary procedure is shown in procedure 570 in FIG. 5. In some embodiments, UE 501 may perform a compliance check on the configuration of the enhanced CPC at another timing. An exemplary procedure is shown in procedure 590 in FIG. 5.

According to procedure 550, in operation 551, UE 501 may perform a compliance check on the configuration of the enhanced CPC in response to the reception of the RRC reconfiguration message for mobility. In response to a failure in the compliance check, UE 501 may transmit failure information to BS 502A (source BS) in operation 553. BS 502A may transmit the failure information to BS 502B (target BS, acting as an MN) in operation 555. BS 502B may transmit the failure information to BS 503 (SN associated with the enhanced CPC) in operation 557.

According to procedure 570, in operation 571, UE 501 may perform a compliance check on the configuration of the enhanced CPC in response to performing the CHO procedure. For example, UE 501 may perform a CHO procedure to the target primary cell of the MSG (e.g., BS 502B) and the target primary cell of the SCG (e.g., target SN) according to the CHO configuration in response to the corresponding execution condition being met. UE 501 may perform a compliance check on the configuration for the enhanced CPC in response to performing the CHO procedure. In the case of a failure in the compliance check, UE 501 may transmit failure information to BS 502B (target BS) in operation 573, in response to the CHO being successfully performed. BS 502B may transmit the failure information to BS 503 (SN associated with the enhanced CPC) in operation 575.

In some embodiments, in procedures 550 and 570, the failure information may be included in an RRC complete message. For example, in response to receiving the RRC reconfiguration message for mobility, UE 501 may transmit an RRC complete message to BS 502A. For example, in response to the CHO being successfully performed, UE 501 may transmit an RRC complete message to BS 502B.

In some embodiments, in procedures 550 and 570, UE 501 may release the configuration for the enhanced CPC in response to the failure in the compliance check.

In some embodiments, in procedures 550 and 570, the failure information may indicate at least one of the following: a candidate PSCell (e.g., by indicating the cell ID) associated with the configuration for the enhanced CPC (e.g., the candidate primary cell of the SCG indicated in this configuration) or a failure type as a reconfiguration failure for enhanced CPC. In the case that a plurality of enhanced CPCs is configured, indicating the candidate PSCell can differentiate which enhanced CPC(s) involves the compliance failure.

According to procedure 590, UE 501 may perform a compliance check on the CHO configuration in response to the reception of the RRC reconfiguration message for mobility or in response to performing the CHO procedure. However, UE 501 may not perform a compliance check on the configuration for the enhanced CPC at the above two timings. In operation 591, UE 501 may perform a CHO procedure to the target primary cell of the MSG (e.g., BS 502B) and the target primary cell of the SCG (e.g., target SN) according to the CHO configuration in response to the corresponding execution condition being met and may successfully perform the CHO.

After the successful CHO, UE 501 may perform the enhanced CPC when the execution condition for the enhanced CPC is met. For example, UE 501 may be connected to the candidate primary cell of the SCG (e.g., BS 503) according to the enhanced CPC while maintain the connection with the target primary cell of the MSG (e.g., BS 502B). That is, after the enhanced CPC, the PSCell of UE 501 may be switched to the candidate primary cell of the SCG associated with the enhanced CPC.

In some embodiments, UE 501 may, in operation 593, perform a compliance check on the configuration for the enhanced CPC in response to the successful CHO or in response to performing the enhanced CPC.

In some embodiments, in response to a failure in the compliance check on the configuration for the enhanced CPC, UE 501 may perform a remedy action. For example, UE 501 may perform a recovery procedure, which may be a re-establishment procedure or SCG failure information procedure.

In some embodiments, in response to a failure in the compliance check on the configuration for the enhanced CPC, UE 501 may transmit failure information to BS 502B (e.g., the target primary cell of the MCG associated with the CHO). BS 502B may transmit the failure information to BS 503 (SN associated with the enhanced CPC).

In some embodiments, the failure information may indicate at least one of the following: a candidate PSCell (e.g., by indicating the cell ID) associated with the configuration for the enhanced CPC (e.g., the candidate primary cell of the SCG indicated in this configuration) or a failure type as a reconfiguration failure for enhanced CPC. In the case that a plurality of enhanced CPCs is configured, indicating the candidate PSCell can differentiate which enhanced CPC(s) involves the compliance failure.

In exemplary procedure 500, UE 501 may perform a compliance check on the CHO configuration in response to the reception of the RRC reconfiguration message for mobility or in response to performing the CHO procedure. UE 501 may perform a remedy action in the case of a failure in the compliance check on the CHO configuration. When UE 501 performs a compliance check on the configuration for the enhanced CPC in response to the reception of the RRC reconfiguration message for mobility or in response to performing the CHO procedure, UE 501 may not perform the remedy action in the case that the compliance check on the CHO configuration is successful but the compliance check on the configuration for the enhanced CPC fails. When UE 501 performs a compliance check on the configuration for the enhanced CPC in response to the successful CHO or in response to performing the enhanced CPC, UE 501 may perform the remedy action in the case that the compliance check on the configuration for the enhanced CPC fails.

It should be appreciated by persons skilled in the art that although the above descriptions with respect to FIG. 5 are described with respect to a CHO, the descriptions can be similarly applied to an ordinary HO, except that, for example, the execution of the ordinary HO does not involve an evaluation of the execution condition for the CHO. For example, in response to receiving the handover request message (e.g., an HO request message), BS 502B may prepare an ordinary HO configuration, instead of a CHO configuration. For example, in response to receiving the RRC reconfiguration message for mobility, UE 501 may perform an ordinary HO.

It should be appreciated by persons skilled in the art that the sequence of the operations in exemplary procedure 500 may be changed and that some of the operations in exemplary procedure 500 may be eliminated or modified, without departing from the spirit and scope of the disclosure.

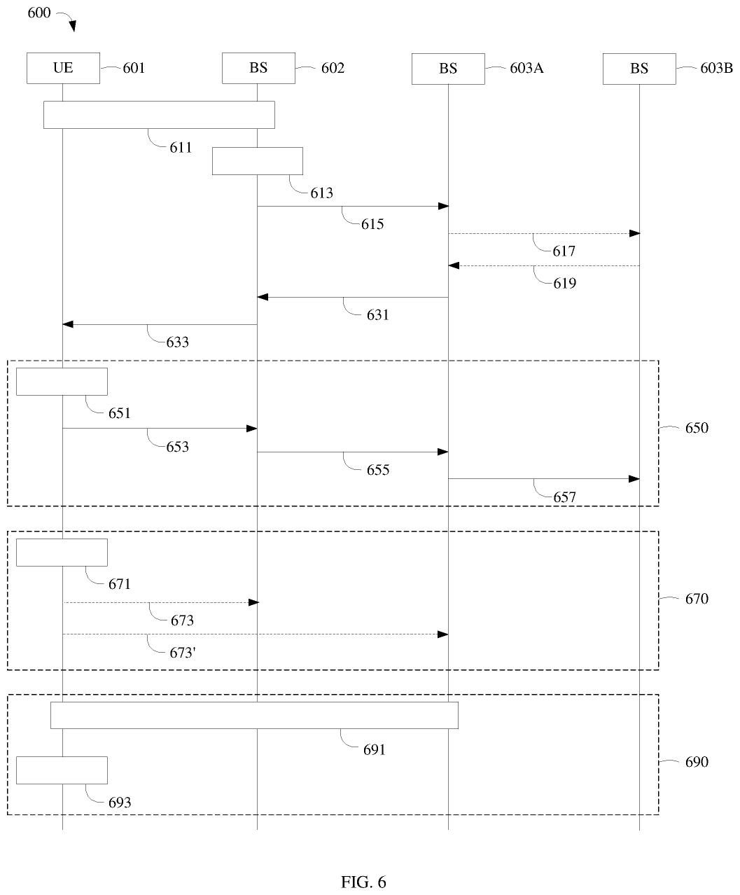

FIG. 6 illustrates a flow chart of exemplary procedure 600 for wireless communications in accordance with some embodiments of the present disclosure. Details described in all of the foregoing embodiments of the present disclosure are applicable for the embodiments shown in FIG. 6.

Referring to FIG. 6, in operation 611, UE 601 may be in a connected state (e.g., RRC_CONNECTED state as specified in 3GPP specifications) and may access its serving cell (e.g., BS 602). In some embodiments, UE 601 may report its UE capability to the serving cell (e.g., BS 602). The UE capability may include at least one of the following:
whether to support an enhanced CPC embedded in a CPA;
whether to support an enhanced CPC embedded in a CPC;
the maximum number of enhanced CPCs that can be embedded in each CPA configuration;
the maximum number of enhanced CPCs that can be embedded in each CPC configuration;
the maximum number of enhanced CPCs that can be embedded in all CPA configurations;
the maximum number of enhanced CPCs that can be embedded in all CPC configurations;
the maximum number of enhanced CPCs that can be embedded in a conditional reconfiguration (e.g., CHO, CPA, or CPC configuration).

UE 601 may transmit measurement reports to the serving cell (e.g., BS 602).

In operation 613, BS 602 (source BS) may determine to configure a CPA or CPC for UE 601. For example, UE 601 may be connected to a single serving BS (e.g., BS 602), which may act as an MN and request another BS (target SN) to configure a CPA for UE 601. For example, UE 601 may be connected to two serving BSs, for example, BS 602 acting as an MN and another BS acting as an SN (hereinafter denoted as SN #0 for clarity). BS 602 may request yet another BS (target SN) to configure a CPC for UE 601.

In operation 615, BS 602 may transmit a request message (e.g., an SN addition request message) to the target SN (e.g., BS 603A) for the CPA or CPC. In some embodiments, BS 602 may indicate BS 603A to prepare an enhanced CPC. For example, the request message may indicate (e.g., by including an indicator) to prepare the enhanced CPC. The enhanced CPC may be performed after the CPA or CPC is performed and an execution condition of the enhanced CPC is met.

In some embodiments, BS 602 may indicate the maximum number of enhanced CPCs (e.g., the maximum number of candidate SCGs for the enhanced CPC or the maximum number of candidate primary cells of an SCG for the enhanced CPC) that is allowed. The maximum number of enhanced CPCs can be per a target SN (e.g., BS 603A) for the CPA or CPC, or per a candidate SN (e.g., BS 603B as will described below).

In some embodiments, BS 602 may indicate a BS to which a candidate PSCell of the enhanced CPC belongs. For example, BS 602 may indicate that the candidate SCG of the enhanced CPC belongs to BS 603A (target SN) or another BS (e.g., BS 603B).

In response to receiving the request message from BS 602, BS 603A may prepare a CPA or CPC configuration, which may indicate a target primary cell of an SCG.

In the case that the enhanced CPC involve a BS (e.g., BS 603B) different from BS 603A (target SN), BS 603A may transmit a request message (e.g., an SN addition request message) to BS 603B (candidate SN) for the enhanced CPC in operation 617 (denoted by a dotted arrow as an option). In some embodiments, the request message to BS 603B may indicate (e.g., by including an indicator) to prepare the enhanced CPC associated with the CPA or CPC. The enhanced CPC may be performed after the CPA or the CPC is performed and an execution condition of the enhanced CPC is met.

In some embodiments, the request message to BS 603B may further indicate at least one of: an ID of BS 602 (source MN), an ID of UE 601, or the maximum number of enhanced CPCs (e.g., the maximum number of candidate SCGs for the enhanced CPC or the maximum number of candidate primary cells of an SCG for the enhanced CPC). In some examples, the maximum number of enhanced CPCs can be per candidate SN (e.g., BS 603B). In some examples, the UE ID may be a Source M-NG-RAN node UE XnAP ID. By including the UE ID, a candidate SN (e.g., BS 603B) may consider that the SN addition preparation procedures that have been triggered for CPC as part of a normal CPC or CPA. For example, the candidate SN may use the Source M-NG-RAN node ID IE and the UE ID (e.g., Source M-NG-RAN node UE XnAP ID IE) to identify other active SN node addition preparations related to a specific UE (e.g., UE 601) for CPC.

In operation 619 (denoted by a dotted arrow as an option), BS 603B may transmit an acknowledgement message (e.g., an SN addition request acknowledgement message) to BS 603A. The acknowledgement message may include the configuration for the enhanced CPC (e.g., a configuration associated with a candidate primary cell of an SCG). In response to receiving the acknowledgement message, BS 603A may add the execution condition(s) for the enhanced CPC.

In the case that the enhanced CPC involve BS 603A (target SN), the above operations 617 and 619 may be omitted.

In operation 631, BS 602A may transmit an acknowledgement message (e.g., an SN addition request acknowledgement message) to BS 602 as a response to the request message in operation 615.

In some embodiments, the acknowledgement message may include the CPA or CPC configuration and the configuration for the enhanced CPC.

In some embodiments, the configuration for the enhanced CPC may be embedded in the CPA or CPC configuration. For example, the CPA or CPC configuration and the configuration for the enhanced CPC may be included in respective RRC reconfiguration messages (e.g., message #1A and message #2A, respectively). Message #2A may be encapsulated (e.g., as a container) in message #1A.

In some embodiments, the CPA or CPC configuration and the configuration for the enhanced CPC may be independently included in the acknowledgement message. For example, the CPA or CPC configuration and the configuration for the enhanced CPC may be arranged in parallel in the acknowledgement message. For example, the acknowledgement message may include message #1A and message #2A in a parallel arrangement.

In operation 633, BS 602 may transmit the CPA or CPC configuration to UE 601, via, for example, an RRC reconfiguration message for mobility (denoted as message #1B).

In some embodiments, message #1B may include both the CPA or CPC configuration and the configuration for the enhanced CPC.

In some embodiments, the configuration for the enhanced CPC may be embedded in the CPA or CPC configuration. For example, the configuration for the enhanced CPC may be included in an RRC reconfiguration message, which may be encapsulated (e.g., as a container) in message #1B.

In some embodiments, the CPA or CPC configuration and the configuration for the enhanced CPC may be independently included in message #1B. For example, the CPA or CPC configuration and the configuration for the enhanced CPC may be arranged in parallel in message #1B.

In some embodiments, the CPA or CPC configuration and the configuration for the enhanced CPC may be transmitted to UE 601 via different messages. For example, besides message #1B, BS 602 may transmit the configuration for the enhanced CPC to UE 601 via another RRC reconfiguration message for mobility (denoted as message #2B).

UE 601 may perform a compliance check on the RRC reconfiguration message for mobility. In some embodiments, UE 601 may perform a compliance check in response to the reception of the RRC reconfiguration message for mobility. An exemplary procedure is shown in procedure 650 in FIG. 6. In some embodiments, UE 601 may perform a compliance check in response to performing the CPA or CPC procedure. An exemplary procedure is shown in procedure 670 in FIG. 6. In some embodiments, UE 601 may perform a compliance check on the configuration of the enhanced CPC at another timing. An exemplary procedure is shown in procedure 690 in FIG. 6.

According to procedure 650, in operation 651, UE 601 may perform a compliance check on the configuration of the enhanced CPC in response to the reception of the RRC reconfiguration message for mobility which includes the configuration of the enhanced CPC. In response to a failure in the compliance check, UE 601 may transmit failure information to BS 602 (source BS) in operation 653. BS 602 may transmit the failure information to BS 603A (target SN) in operation 655. BS 603A may transmit the failure information to BS 603B (SN associated with the enhanced CPC) in operation 657.

According to procedure 670, in operation 671, UE 601 may perform a compliance check on the configuration of the enhanced CPC in response to performing the CPA or CPC procedure. For example, UE 601 may perform a CPA or CPC procedure to the target primary cell of the SCG (e.g., BS 603A) according to the CPA or CPC configuration in response to the corresponding execution condition being met. UE 601 may perform a compliance check on the configuration for the enhanced CPC in response to performing the CPA or CPC procedure.

In the case of a failure in the compliance check, UE 601 may transmit failure information to BS 602 (source MN) in operation 673 or BS 603A (target SN) in operation 673′, in response to the CPA or CPC being successfully performed. For example, if the enhanced CPC is transmitted by BS 602 (source MN) to UE 601 via the MCG link, UE 601 may transmit the failure information to BS 602 (source MN) in the case of compliance failure. For example, if the enhanced CPC is transmitted by an SN (e.g., SN #0) to UE 601 via the SCG link, UE 601 may transmit the failure information to BS 603A (target SN) in the case of compliance failure. BS 602 or BS 603A may transmit the failure information to BS 603B (SN associated with the enhanced CPC) (not shown in procedure 670).

In some embodiments, in procedures 650 and 670, the failure information may be included in an RRC complete message. For example, in response to receiving the RRC reconfiguration message for mobility, UE 601 may transmit an RRC complete message to BS 602. For example, in response to the CPA or CPC being successfully performed, UE 601 may transmit an RRC complete message to BS 603A.

In some embodiments, in procedures 650 and 670, UE 601 may release the configuration for the enhanced CPC in response to the failure in the compliance check.

In some embodiments, in procedures 650 and 670, the failure information may indicate at least one of the following: a candidate PSCell (e.g., by indicating the cell ID) associated with the configuration for the enhanced CPC (e.g., the candidate primary cell of the SCG indicated in this configuration) or a failure type as a reconfiguration failure for enhanced CPC. In the case that a plurality of enhanced CPCs is configured, indicating the candidate PSCell can differentiate which enhanced CPC(s) involves the compliance failure.

According to procedure 690, UE 601 may perform a compliance check on the CPA or CPC configuration in response to the reception of the RRC reconfiguration message for mobility including the configuration or in response to performing the CPA or CPC procedure. However, UE 601 may not perform a compliance check on the configuration for the enhanced CPC at the above two timings. In operation 691, UE 601 may perform a CPA or CPC procedure to the target primary cell of the SCG (e.g., BS 603A) according to the CPA or CPC configuration in response to the corresponding execution condition being met and may successfully perform the CPA or CPC.

After the successful CPA or CPC, UE 601 may perform the enhanced CPC when the execution condition for the enhanced CPC is met. For example, UE 601 may be switch to the candidate primary cell of the SCG (e.g., BS 603B) according to the enhanced CPC. That is, after the enhanced CPC, the PSCell of UE 601 may be switched to the candidate primary cell of the SCG associated with the enhanced CPC.

In some embodiments, UE 601 may, in operation 693, perform a compliance check on the configuration for the enhanced CPC in response to the successful CPA or CPC, or in response to performing the enhanced CPC.

In some embodiments, in response to a failure in the compliance check on the configuration for the enhanced CPC, UE 601 may perform a remedy action. For example, UE 601 may perform a recovery procedure, which may be a re-establishment procedure or SCG failure information procedure.

In some embodiments, in response to a failure in the compliance check on the configuration for the enhanced CPC, UE 601 may transmit failure information to BS 602 (source MN) or BS 603A (target SN). For example, if the enhanced CPC is transmitted by an SN (e.g., SN #0) to UE 601 via the SCG link, UE 601 may transmit the failure information to BS 603A (target SN) in the case of compliance failure. BS 602 or BS 603A may transmit the failure information to BS 603B (SN associated with the enhanced CPC).

In some embodiments, the failure information may indicate at least one of the following: a candidate PSCell (e.g., by indicating the cell ID) associated with the configuration for the enhanced CPC (e.g., the candidate primary cell of the SCG indicated in this configuration) or a failure type as a reconfiguration failure for enhanced CPC. In the case that a plurality of enhanced CPCs is configured, indicating the candidate PSCell can differentiate which enhanced CPC(s) involves the compliance failure.

In exemplary procedure 600, UE 601 may perform a compliance check on the CPA or CPC configuration in response to the reception of the RRC reconfiguration message for mobility including the configuration or in response to performing the CPA or CPC procedure. UE 601 may perform a remedy action in the case of a failure in the compliance check on the CPA or CPC configuration. When UE 601 performs a compliance check on the configuration for the enhanced CPC in response to the reception of the RRC reconfiguration message for mobility or in response to performing the CPA or CPC procedure, UE 601 may not perform the remedy action in the case that the compliance check on the CPA or CPC configuration is successful but the compliance check on the configuration for the enhanced CPC fails. When UE 601 performs a compliance check on the configuration for the enhanced CPC in response to the successful CPA or CPC or in response to performing the enhanced CPC, UE 601 may perform the remedy action in the case that the compliance check on the configuration for the enhanced CPC fails.

It should be appreciated by persons skilled in the art that the sequence of the operations in exemplary procedure 600 may be changed and that some of the operations in exemplary procedure 600 may be eliminated or modified, without departing from the spirit and scope of the disclosure.

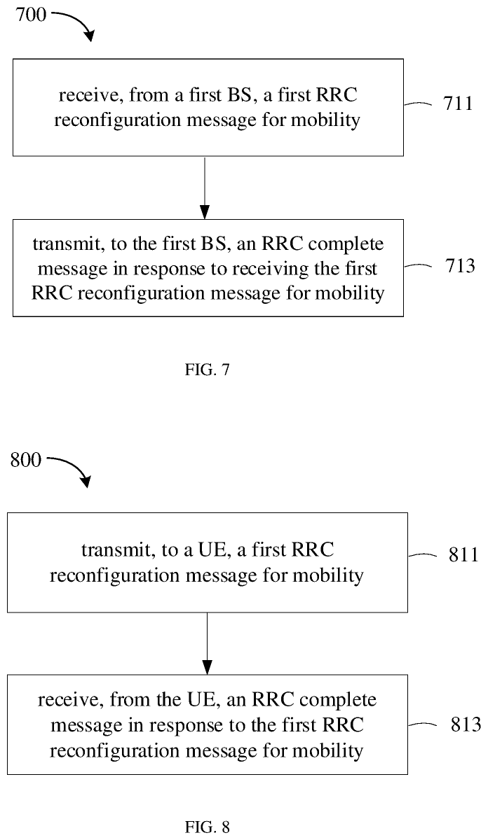

FIG. 7 illustrates a flow chart of exemplary procedure 700 for UE mobility in accordance with some embodiments of the present disclosure. Details described in all of the foregoing embodiments of the present disclosure are applicable for the embodiments shown in FIG. 7. In some examples, the procedure may be performed by a UE.

Referring to FIG. 7, in operation 711, a UE may receive, from a BS (denoted as “first BS” for clarity), an RRC reconfiguration message for mobility (denoted as “first RRC reconfiguration message for mobility” for clarity). In operation 713, the UE may transmit, to the first BS, an RRC complete message in response to receiving the first RRC reconfiguration message for mobility. The first RRC reconfiguration message for mobility may be associated with an enhanced CPA or an enhanced CPC.

In some embodiments, a configuration for the enhanced CPA or a configuration for the enhanced CPC is included in a second RRC reconfiguration message which is encapsulated in the first RRC reconfiguration message for mobility.

In some embodiments, the UE may perform a compliance check on a configuration for the enhanced CPA or a configuration for the enhanced CPC in response to receiving the first RRC reconfiguration message for mobility. The UE may transmit failure information to the first BS in response to a failure in the compliance check. The failure information may indicate at least one of the following: a candidate PSCell associated with the configuration for the enhanced CPA or the configuration for the enhanced CPC; or a failure type as a reconfiguration failure for enhanced CPA or CPC.

In some embodiments, the first RRC reconfiguration message for mobility may include: (1) a first conditional handover (CHO) configuration indicating a target primary cell of a master cell group and a first configuration for the enhanced CPA associated with a candidate primary cell of a secondary cell group, wherein the enhanced CPA is performed after the CHO is performed and an execution condition for the enhanced CPA is met; (2) a second CHO configuration indicating a target primary cell of a master cell group and a target primary cell of a secondary cell group and a second configuration for the enhanced CPC associated with a candidate primary cell of a secondary cell group, wherein the enhanced CPC is performed after the CHO is performed and an execution condition for the enhanced CPC is met; (3) a third configuration for a CPA associated with a target primary cell of a secondary cell group and a third configuration for the enhanced CPC associated with a candidate primary cell of a secondary cell group, wherein the enhanced CPC is performed after the CPA is performed and an execution condition of the enhanced CPC is met; or (4) a fourth configuration for a CPC associated with a target primary cell of a secondary cell group and a fourth configuration for the enhanced CPC associated with a candidate primary cell of a secondary cell group, wherein the enhanced CPC is performed after the CPC is performed and an execution condition of the enhanced CPC is met.

In some embodiments, the UE may perform at least one of the following: performing a first CHO procedure to the target primary cell of the master cell group according to the first CHO configuration, and performing a compliance check on the first configuration for the enhanced CPA in response to performing the first CHO procedure; performing a second CHO procedure to the target primary cell of the master cell group and the target primary cell of the secondary cell group according to the second CHO configuration, and performing a compliance check on the second configuration for the enhanced CPC in response to performing the second CHO procedure; performing a CPA procedure with the target primary cell of the secondary cell group according to the third configuration for a CPA, and performing a compliance check on the third configuration for the enhanced CPC in response to performing the CPA procedure; or performing a CPC procedure with the target primary cell of the secondary cell group according to the fourth configuration for a CPC, and performing a compliance check on the fourth configuration for the enhanced CPC in response to performing the CPC procedure.

In some embodiments, the UE may perform at least one of the following: in the case of a failure in the compliance check on the first configuration for the enhanced CPA, transmitting failure information to the target primary cell of the master cell group in response to the first CHO procedure being successful; in the case of a failure in the compliance check on the second configuration for the enhanced CPC, transmitting failure information to the target primary cell of the master cell group in response to the second CHO procedure being successful; in the case of a failure in the compliance check on the third configuration for the enhanced CPC, transmitting failure information to the first BS or the target primary cell of the secondary cell group in response to the CPA procedure being successful; or in the case of a failure in the compliance check on the fourth configuration for the enhanced CPC configuration, transmitting failure information to the first BS or the target primary cell of the secondary cell group in response to the CPC procedure being successful.

In some embodiments, the UE may release the configuration for the enhanced CPA or the configuration for the enhanced CPC in response to a failure in the compliance check.

In some embodiments, the failure information may be transmitted via the RRC complete message.

In some embodiments, the UE may perform at least one of the following: performing a compliance check on the first configuration for the enhanced CPA in response to a successful CHO to the target primary cell of the master cell group; performing a compliance check on the second configuration for the enhanced CPC in response to a successful CHO to the target primary cell of the master cell group and the target primary cell of the secondary cell group; performing a compliance check on the third configuration for the enhanced CPC in response to a successful CPA procedure with the target primary cell of the secondary cell group; or performing a compliance check on the fourth configuration for the enhanced CPC in response to a successful CPC procedure with the target primary cell of the secondary cell group. In some embodiments, the UE may perform a recovery procedure in response to a failure in the compliance check.

In some embodiments, the UE may perform at least one of the following: performing a first CPA procedure according to the first configuration for the enhanced CPA after a successful CHO to the target primary cell of the master cell group, and performing a compliance check on the first configuration for the enhanced CPA in response to performing the first CPA procedure; performing a second CPC procedure according to the second configuration for the enhanced CPC after a successful CHO to the target primary cell of the master cell group and the target primary cell of the secondary cell group, and performing a compliance check on the second configuration for the enhanced CPC in response to performing the second CPC procedure; performing a third CPC procedure according to the third configuration for the enhanced CPC after a successful CPA procedure with the target primary cell of the secondary cell group, and performing a compliance check on the third configuration for the enhanced CPC in response to performing the third CPC procedure; or performing a fourth CPC procedure according to the fourth configuration for the enhanced CPC after a successful CPC procedure with the target primary cell of the secondary cell group, and performing a compliance check on the fourth configuration for the enhanced CPC in response to performing the fourth CPC procedure. In some embodiments, the UE may perform a recovery procedure in response to a failure in the compliance check.

In some embodiments, the UE may perform at least one of the following: in the case of a failure in the compliance check on the first configuration for the enhanced CPA, transmitting failure information to the target primary cell of the master cell group in response to a successful CHO to the target primary cell of the master cell group; in the case of a failure in the compliance check on the second configuration for the enhanced CPC, transmitting failure information to the target primary cell of the master cell group in response to a successful CHO to the target primary cell of the master cell group and the target primary cell of the secondary cell group; in the case of a failure in the compliance check on the third configuration for the enhanced CPC, transmitting failure information to the first BS or the target primary cell of the secondary cell group in response to a successful CPA procedure with the target primary cell of the secondary cell group; or in the case of a failure in the compliance check on the third configuration for the enhanced CPC, transmitting failure information to the first BS or the target primary cell of the secondary cell group in response to a successful CPC procedure with the target primary cell of the secondary cell group.

In some embodiments, the failure information indicates at least one of the following: a ID of the candidate primary cell of the secondary cell group associated with the first configuration for the enhanced CPA, the second configuration for the enhanced CPC, the third configuration for the enhanced CPC, or the fourth configuration for the enhanced CPC; or a failure type as a reconfiguration failure for enhanced CPA or CPC.

It should be appreciated by persons skilled in the art that the sequence of the operations in exemplary procedure 700 may be changed and some of the operations in exemplary procedure 700 may be eliminated or modified, without departing from the spirit and scope of the disclosure.

FIG. 8 illustrates a flow chart of exemplary procedure 800 for UE mobility in accordance with some embodiments of the present disclosure. Details described in all of the foregoing embodiments of the present disclosure are applicable for the embodiments shown in FIG. 8. In some examples, the procedure may be performed by a BS.

Referring to FIG. 8, in operation 811, a BS (denoted as “first BS” for clarity) may transmit, to a UE, an RRC reconfiguration message for mobility (denoted as “first RRC reconfiguration message for mobility” for clarity). For example, the first BS may be BS 402A in FIG. 4, BS 502A in FIG. 5 or BS 602 in FIG. 6.

In operation 813, the first BS may receive, from the UE, an RRC complete message in response to the first RRC reconfiguration message for mobility. The first RRC reconfiguration message for mobility may be associated with an enhanced CPA or an enhanced CPC.

In some embodiments of the present disclosure, the first BS may transmit, to another BS (denoted as “second BS” for clarity), an HO request message for a CHO. The HO request message may indicate to prepare the enhanced CPA or the enhanced CPC. For example, the second BS may be BS 402B in FIG. 4 or BS 502B in FIG. 5.

In some embodiments, the first BS may receive, from the second BS, an HO request acknowledge message in response to the HO request message. The HO request acknowledge message may include: a first CHO configuration indicating a target primary cell of a master cell group and a first configuration for the enhanced CPA associated with a candidate primary cell of a secondary cell group, wherein the enhanced CPA is performed after the CHO is performed and an execution condition for the enhanced CPA is met; or a second CHO configuration indicating a target primary cell of a master cell group and a target primary cell of a secondary cell group and a second configuration for the enhanced CPC associated with a candidate primary cell of a secondary cell group, wherein the enhanced CPC is performed after the CHO is performed and an execution condition for the enhanced CPC is met.

In some embodiments, the first configuration for the enhanced CPA is encapsulated in the first CHO configuration or the second configuration for the enhanced CPC is encapsulated in the second CHO configuration. In some embodiments, the first configuration for the enhanced CPA is included in the HO request acknowledge message independently of the first CHO configuration or the second configuration for the enhanced CPC is included in the HO request acknowledge message independently of the second CHO configuration.

In some embodiments of the present disclosure, the first BS may transmit, to a second BS, a request message for a CPA or a CPC, wherein the request message indicates to prepare the enhanced CPC. For example, the second BS may be BS 603A in FIG. 6. In some embodiments, the request message may further indicate a BS to which a candidate PSCell of the enhanced CPC belongs.

In some embodiments, the first BS may receive, from the second BS, an acknowledge message in response to the request message. The acknowledge message may include: a third configuration for the CPA associated with a target primary cell of a secondary cell group and a third configuration for the enhanced CPC associated with a candidate primary cell of a secondary cell group, wherein the enhanced CPC is performed after the CPA is performed and an execution condition of the enhanced CPC is met; or a fourth configuration for a CPC associated with a target primary cell of a secondary cell group and a fourth configuration for the enhanced CPC associated with a candidate primary cell of a secondary cell group, wherein the enhanced CPC is performed after the CPC is performed and an execution condition of the enhanced CPC is met.

In some embodiments, the third configuration for the enhanced CPC may be encapsulated in the third configuration for the CPA. In some embodiments, the fourth configuration for the enhanced CPC may be encapsulated in the fourth configuration for the CPC.

In some embodiments of the present disclosure, the first RRC reconfiguration message for mobility may be encapsulated with a second RRC reconfiguration message including a configuration for the enhanced CPA or a configuration for the enhanced CPC.

In some embodiments of the present disclosure, the first BS may receive, from the UE, failure information associated with a compliance check on the enhanced CPA or enhanced CPC. In some embodiments, the failure information may be received via the RRC complete message. In some embodiments, the failure information may indicate at least one of the following: a candidate primary cell of a secondary cell group associated with the enhanced CPA or enhanced CPC; or a failure type as a reconfiguration failure for enhanced CPA or CPC.

It should be appreciated by persons skilled in the art that the sequence of the operations in exemplary procedure 800 may be changed and some of the operations in exemplary procedure 800 may be eliminated or modified, without departing from the spirit and scope of the disclosure.

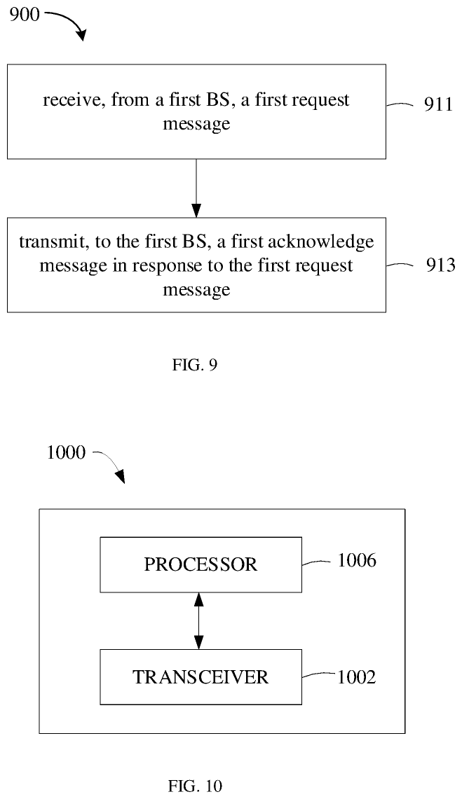

FIG. 9 illustrates a flow chart of an exemplary procedure 900 for UE mobility in accordance with some embodiments of the present disclosure. Details described in all of the foregoing embodiments of the present disclosure are applicable for the embodiments shown in FIG. 9. In some examples, the procedure may be performed by a BS.

Referring to FIG. 9, in operation 911, a BS (denoted as “second BS” for clarity) may receive, from another BS (denoted as “first BS” for clarity), a request message (denoted as “first request message” for clarity). The first request message may indicate to prepare an enhanced CPA or an enhanced CPC for a UE.

In operation 913, the second BS may transmit, to the first BS, an acknowledge message (denoted as “first acknowledge message” for clarity) in response to the first request message. For example, the first BS may be BS 402A in FIG. 4, BS 502A in FIG. 5 or BS 602 in FIG. 6. For example, the second BS may be BS 402B in FIG. 4, BS 502B in FIG. 5 or BS 603A in FIG. 6.

In some embodiments of the present disclosure, the first request message may be a handover (HO) request message for a conditional HO (CHO).

In some embodiments, the second BS may transmit a second request message to a third BS to indicate to prepare the enhanced CPA or the enhanced CPC associate with the CHO, wherein the enhanced CPA or the enhanced CPC is performed after the CHO is performed and an execution condition of the enhanced CPA or the enhanced CPC is met. The second BS may receive a second acknowledge message in response to the second request message, wherein the second acknowledge message includes a configuration for the enhanced CPA or the enhanced CPC.

In some embodiments, the second request message may indicate at least one of the following: an ID of the first BS; an ID of the UE; or a maximum number of enhanced CPAs or CPCs.

In some embodiments, transmitting the first acknowledge message may include: transmitting a configuration for the CHO and the configuration for the enhanced CPA; or transmitting a configuration for the CHO and the configuration for the enhanced CPC.

In some embodiments, the configuration for the enhanced CPA or the enhanced CPC is encapsulated in the configuration for the CHO. In some embodiments, wherein the configuration for the enhanced CPA or the enhanced CPC and the configuration for the CHO are independently included in the first acknowledge message.

In some embodiments of the present disclosure, the first request message may be a request message for a CPA or a CPC. In some embodiments, the first request message may further indicate a BS to which a candidate PSCell of the enhanced CPC belongs.

In some embodiments, the second BS may transmit a second request message to a third BS to indicate to prepare the enhanced CPC associate with the CPA or the CPC, wherein the enhanced CPC is performed after the CPA or the CPC is performed and an execution condition of the enhanced CPC is met. In some embodiments, the second BS may receive a second acknowledge message in response to the second request message, wherein the second acknowledge message includes a configuration for the enhanced CPC.

In some embodiments, the second request message may indicate at least one of the following: an ID of the first BS; an ID of the UE; or a maximum number of enhanced CPCs.

In some embodiments, transmitting the first acknowledge message may include: transmitting a configuration for the CPA and the configuration for the enhanced CPC; or transmitting a configuration for the CPC and the configuration for the enhanced CPC.

In some embodiments, the configuration for the enhanced CPC is encapsulated in the configuration for the CPA or CPC. In some embodiments, the configuration for the enhanced CPC and the configuration for the CPA or CPC are independently included in the first acknowledge message.

In some embodiments of the present disclosure, the second BS may receive, from the first BS, failure information associated with a compliance check on the enhanced CPA or enhanced CPC; and transmit the failure information to a candidate PSCell associated with the enhanced CPA or enhanced CPC. In some embodiments, the failure information may indicate at least one of the following: an ID of the candidate PSCell associated with the enhanced CPA or enhanced CPC; or a failure type as a reconfiguration failure for enhanced CPA or CPC.

It should be appreciated by persons skilled in the art that the sequence of the operations in exemplary procedure 900 may be changed and some of the operations in exemplary procedure 900 may be eliminated or modified, without departing from the spirit and scope of the disclosure.

FIG. 10 illustrates a block diagram of an exemplary apparatus 1000 according to some embodiments of the present disclosure.

As shown in FIG. 10, the apparatus 1000 may include at least one processor 1006 and at least one transceiver 1002 coupled to the processor 1006. The apparatus 1000 may be a BS or a UE.

Although in this figure, elements such as the at least one transceiver 1002 and processor 1006 are described in the singular, the plural is contemplated unless a limitation to the singular is explicitly stated. In some embodiments of the present application, the transceiver 1002 may be divided into two devices, such as a receiving circuitry and a transmitting circuitry. In some embodiments of the present application, the apparatus 1000 may further include an input device, a memory, and/or other components.

In some embodiments of the present application, the apparatus 1000 may be a UE. The transceiver 1002 and the processor 1006 may interact with each other so as to perform the operations with respect to the UEs described in FIGS. 1-9. In some embodiments of the present application, the apparatus 1000 may be a BS. The transceiver 1002 and the processor 1006 may interact with each other so as to perform the operations with respect to the BSs described in FIGS. 1-9.

In some embodiments of the present application, the apparatus 1000 may further include at least one non-transitory computer-readable medium.

For example, in some embodiments of the present disclosure, the non-transitory computer-readable medium may have stored thereon computer-executable instructions to cause the processor 1006 to implement the method with respect to the UEs as described above. For example, the computer-executable instructions, when executed, cause the processor 1006 interacting with transceiver 1002 to perform the operations with respect to the UEs described in FIGS. 1-9.

In some embodiments of the present disclosure, the non-transitory computer-readable medium may have stored thereon computer-executable instructions to cause the processor 1006 to implement the method with respect to the BSs as described above. For example, the computer-executable instructions, when executed, cause the processor 1006 interacting with transceiver 1002 to perform the operations with respect to the BSs described in FIGS. 1-9.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
receive, from a first base station, a first radio resource control (RRC) reconfiguration message for mobility; and
transmit, to the first base station, an RRC complete message in response to receiving the first RRC reconfiguration message for mobility,
wherein the first RRC reconfiguration message for mobility is associated with an enhanced conditional primary secondary cell (PSCell) addition (CPA) or an enhanced conditional PSCell change (CPC).

2. The UE of claim 1, wherein the first RRC reconfiguration message for mobility includes:
a first conditional handover (CHO) configuration indicating a target primary cell of a master cell group and a first configuration for the enhanced CPA associated with a candidate primary cell of a secondary cell group, wherein the enhanced CPA is performed after the CHO is performed and an execution condition for the enhanced CPA is met;
a second CHO configuration indicating a target primary cell of a master cell group and a target primary cell of a secondary cell group and a second configuration for the enhanced CPC associated with a candidate primary cell of a secondary cell group, wherein the enhanced CPC is performed after the CHO is performed and an execution condition for the enhanced CPC is met;
a third configuration for a CPA associated with a target primary cell of a secondary cell group and a third configuration for the enhanced CPC associated with a candidate primary cell of a secondary cell group, wherein the enhanced CPC is performed after the CPA is performed and an execution condition of the enhanced CPC is met; or
a fourth configuration for a CPC associated with a target primary cell of a secondary cell group and a fourth configuration for the enhanced CPC associated with a candidate primary cell of a secondary cell group, wherein the enhanced CPC is performed after the CPC is performed and an execution condition of the enhanced CPC is met.

3. The UE of claim 1, wherein a configuration for the enhanced CPA or a configuration for the enhanced CPC is included in a second RRC reconfiguration message which is encapsulated in the first RRC reconfiguration message for mobility.

4. The UE of claim 1, wherein the at least one processor is configured to cause the UE to perform a compliance check on a configuration for the enhanced CPA or a configuration for the enhanced CPC in response to receiving the first RRC reconfiguration message for mobility.

5. The UE of claim 4, wherein the at least one processor is configured to cause the UE to transmit failure information to the first base station in response to a failure in the compliance check.

6. The UE of claim 5, wherein the failure information indicates at least one of the following:
a candidate PSCell associated with the configuration for the enhanced CPA or the configuration for the enhanced CPC; or
a failure type as a reconfiguration failure for enhanced CPA or CPC.

7. The UE of claim 2, wherein the at least one processor is configured to cause the UE to perform at least one of the following:
perform a first CHO procedure to the target primary cell of the master cell group according to the first CHO configuration, and perform a compliance check on the first configuration for the enhanced CPA in response to performing the first CHO procedure;
perform a second CHO procedure to the target primary cell of the master cell group and the target primary cell of the secondary cell group according to the second CHO configuration, and perform a compliance check on the second configuration for the enhanced CPC in response to performing the second CHO procedure;
perform a CPA procedure with the target primary cell of the secondary cell group according to the third configuration for a CPA, and perform a compliance check on the third configuration for the enhanced CPC in response to performing the CPA procedure; or
perform a CPC procedure with the target primary cell of the secondary cell group according to the fourth configuration for a CPC, and perform a compliance check on the fourth configuration for the enhanced CPC in response to performing the CPC procedure.

8. The UE of claim 7, wherein the at least one processor is configured to cause the UE to perform at least one of the following:
in the case of a failure in the compliance check on the first configuration for the enhanced CPA, transmit failure information to the target primary cell of the master cell group in response to the first CHO procedure being successful;
in the case of a failure in the compliance check on the second configuration for the enhanced CPC, transmit failure information to the target primary cell of the master cell group in response to the second CHO procedure being successful;
in the case of a failure in the compliance check on the third configuration for the enhanced CPC, transmit failure information to the first BS or the target primary cell of the secondary cell group in response to the CPA procedure being successful; or
in the case of a failure in the compliance check on the fourth configuration for the enhanced CPC configuration, transmit failure information to the first BS or the target primary cell of the secondary cell group in response to the CPC procedure being successful.

9. The UE of claim 7, wherein the at least one processor is configured to cause the UE to release the configuration for the enhanced CPA or the configuration for the enhanced CPC in response to a failure in the compliance check.

10. The UE of claim 8, wherein the failure information is transmitted via the RRC complete message.

11. The UE of claim 2, wherein the at least one processor is configured to cause the UE to perform at least one of the following:
perform a compliance check on the first configuration for the enhanced CPA in response to a successful CHO to the target primary cell of the master cell group;
perform a compliance check on the second configuration for the enhanced CPC in response to a successful CHO to the target primary cell of the master cell group and the target primary cell of the secondary cell group;
perform a compliance check on the third configuration for the enhanced CPC in response to a successful CPA procedure with the target primary cell of the secondary cell group; or
perform a compliance check on the fourth configuration for the enhanced CPC in response to a successful CPC procedure with the target primary cell of the secondary cell group.

12. The UE of claim 2, wherein the at least one processor is configured to cause the UE to perform at least one of the following:
perform a first CPA procedure according to the first configuration for the enhanced CPA after a successful CHO to the target primary cell of the master cell group, and perform a compliance check on the first configuration for the enhanced CPA in response to performing the first CPA procedure;
perform a second CPC procedure according to the second configuration for the enhanced CPC after a successful CHO to the target primary cell of the master cell group and the target primary cell of the secondary cell group, and perform a compliance check on the second configuration for the enhanced CPC in response to performing the second CPC procedure;
perform a third CPC procedure according to the third configuration for the enhanced CPC after a successful CPA procedure with the target primary cell of the secondary cell group, and perform a compliance check on the third configuration for the enhanced CPC in response to performing the third CPC procedure; or
perform a fourth CPC procedure according to the fourth configuration for the enhanced CPC after a successful CPC procedure with the target primary cell of the secondary cell group, and perform a compliance check on the fourth configuration for the enhanced CPC in response to performing the fourth CPC procedure.

13. The UE of claim 12, wherein the at least one processor is configured to cause the UE to perform a recovery procedure in response to a failure in the compliance check.

14. A first base station (B-S), comprising:
at least one memory; and
at least one processor coupled with the at least one memory and configured to cause the first base station to:
transmit, to a user equipment (UE), a first radio resource control (RRC) reconfiguration message for mobility; and
receive, from the UE, an RRC complete message in response to the first RRC reconfiguration message for mobility,
wherein the first RRC reconfiguration message for mobility is associated with an enhanced conditional primary secondary cell (PSCell) addition (CPA) or an enhanced conditional PSCell change (CPC).

15. A second base station, comprising:
at least one memory; and
at least one processor coupled with the at least one memory and configured to cause the second base station to:
receive, from a first base station, a first request message, wherein the first request message indicates to prepare an enhanced conditional primary secondary cell (PSCell) addition (CPA) or an enhanced conditional PSCell change (CPC) for a user equipment (UE); and
transmit, to the first base station, a first acknowledge message in response to the first request message.

16. The second base station of claim 15, wherein the first request message is a handover (HO) request message for a conditional HO (CHO).

17. The second base station of claim 17, wherein the at least one processor is configured to cause the second base station to:
transmit a second request message to a third base station to indicate to prepare the enhanced CPA or the enhanced CPC associate with the CHO, wherein the enhanced CPA or the enhanced CPC is performed after the CHO is performed and an execution condition of the enhanced CPA or the enhanced CPC is met; and
receive a second acknowledge message in response to the second request message, wherein the second acknowledge message includes a configuration for the enhanced CPA or the enhanced CPC.

18. The first base station of claim 14, wherein the at least one processor is configured to cause the first base station to transmit, to a second base station, a handover (HO) request message for a conditional HO (CHO), wherein the HO request message indicates to prepare the enhanced CPA or the enhanced CPC.

19. The first base station of claim 18, wherein the at least one processor is configured to cause the first base station to receive, from the second base station, a HO request acknowledge message in response to the HO request message, wherein the HO request acknowledge message comprises:
a first CHO configuration indicating a target primary cell of a master cell group and a first configuration for the enhanced CPA associated with a candidate primary cell of a secondary cell group, wherein the enhanced CPA is performed after the CHO is performed and an execution condition for the enhanced CPA is met; or
a second CHO configuration indicating a target primary cell of a master cell group and a target primary cell of a secondary cell group and a second configuration for the enhanced CPC associated with a candidate primary cell of a secondary cell group, wherein the enhanced CPC is performed after the CHO is performed and an execution condition for the enhanced CPC is met.

20. A processor for wireless communication, comprising:
at least one controller coupled with at least one memory and configured to cause the processor to:
receive, from a first base station, a first radio resource control (RRC) reconfiguration message for mobility; and
transmit, to the first base station, an RRC complete message in response to receiving the first RRC reconfiguration message for mobility,
wherein the first RRC reconfiguration message for mobility is associated with an enhanced conditional primary secondary cell (PSCell) addition (CPA) or an enhanced conditional PSCell change (CPC).
